(19) United States
(12) Patent Application Publication
(10) Pub. No.: US 2014/0164342 A1
(43) Pub. Date: Jun. 12, 2014

(54) HUMAN THREADING SEARCH ENGINE

(71) Applicant: HUMAN THREADING CORPORATION, Los Angeles, CA (US)

(72) Inventor: Christopher G. Liapis, Hermosa Beach, CA (US)

(73) Assignee: HUMAN THREADING CORPORATION, Los Angeles, CA (US)

(21) Appl. No.: 13/801,917

(22) Filed: Mar. 13, 2013

Related U.S. Application Data
(60) Provisional application No. 61/735,952, filed on Dec. 11, 2012.

(51) Int. Cl. G06F 17/30

(52) U.S. Cl. CPC G06F 17/30864
USPC 707/706

(57) ABSTRACT

A set of methods which build on top of search engine page rank which use sentiment analysis, entity extrapolation, temporal analysis, cluster analysis, geographic, and multimedia content to provide visualizations of search results. Rather than a single list of ranked text, these methods extract: people, places and things directly from search engine results pages as well as how they are related to each other.

### CROSS-REFERENCE TO RELATED APPLICATION

This application claims priority to U.S. Application Ser. No. 61/735,952, entitled “Human Threading Search Engine,” filed Dec. 11, 2012, the entirety of each of which is hereby incorporated herein by this reference as if fully set forth herein.

### FIELD OF INVENTION

The present inventions relate to search engines, and more particularly, to the generation of a more neurologically efficient search engine.

### BACKGROUND

Present day search engines strive to take a user's question and quickly return results linking to webpages which may answer it. These returned search results come primarily in the form of text where they are listed in ascending order from most relevant to least relevant. An important aspect of this technology focuses on search rank or page rank mathematics where a set of metrics determines the listed order of webpage results. However, recent research in cognitive science indicates that such lists may not be the most natural way for humans to process the meaning of the search results. It is desirable to have a search engine that can assist humans in more natural way than reading a list of search results.

### SUMMARY OF PREFERRED EMBODIMENTS

Some embodiments relate to methods building on top of current search engine mathematics, and more particularly, to the generation of a more neurologically efficient search engine through unique transformations of text into interactive visualizations. Some embodiments include an engine which reads the content of the webpage resulting from a user's query and reveals relevant information about the webpage results such as people, places and things (and how they are all related) through interactive visualizations.

In some embodiments, a search engine is provided which has been constructed to assist humans in a more natural way than reading a list of text. Specifically, this engine has been created to be a human-centric search platform, exercising patterns and objects which efficiently unveil patterns or trends in the data. Some embodiments allow the user to read less text, and to utilize visualizations to show users what they need to know regarding their question in the form of patterns.

A process according to some embodiments takes in a user's search question and passes the resultant websites to an internal engine which reads some or all of the content from the websites. While the engine processes each site, certain attributes of the website are remembered, such as names, dates, organizations, the website title, and more. Finally, the engine is able to amass all of the information it needs from reading the website results and produces visualizations for the user to process visually. The resultant visualizations provide the advantage of a neurological difference between utilizing pattern recognition through visualizations and reading language characters, the latter being a slower form of pattern recognition.

Visualizations are comprised of both inductive and deductive logic. Specifically, a simple visualization may be comprised of a screenshot image showing a webpage while a more complex visualization may take information from several webpages and link them all together. For example, a search on ‘Madonna’ may show many of the current organizations the pop star Madonna is currently working with, or what people she is associated with, and how those people and organizations are related to each other through Madonna.

As this is a search engine, achieving optimal time complexity is contributes to its success as such socket programming will use a distributed network environment working in unison to provide the user with a fast, more intuitive result. The algorithms described reside on multiple servers, all of which are working simultaneously to quickly piece together the result pages. Servers in this case will include physical (bare metal) hardware, a hypervisor, and integrated guest environments. Switching will also be both physical and virtual.

Some embodiments described herein include the following processes and features:

Connections Results Page. According to some embodiments, the process includes taking search results, extracting people, places, and things and visually showing how they all connect to each other and the respective websites that each are mentioned in.

Locations Results Page. According to some embodiments, a search engine produces a results page that discovers locations mentioned in search engine results pages and plots those locations on a three dimensional globe with globe markers showing the locations and heat map showing the hotspots or most talked about region(s). Those globe markers may then be clicked to reveal the website(s) mentioning that place on the globe.

Media Wall Results Page. According to some embodiments for searching and displaying multimedia, which includes, rather than simply searching for multimedia based on the search word or phrase, a search of that word or phrase added with other trending topics found such as people, places, and/or things.

Sentiment Results Page. According to some embodiments, a process includes taking webpage results, sending them through my ‘Mining Engine’, and producing a sentiment analysis results page showing different dimensions of sentiment in additional to positive/neutral/or negative sentiments.

Main Topics Page. According to some embodiments, a process includes using clustering mathematics to read webpage results in an effort to ultimately build a bookshelf where each book's title is one of the main topics that is generated. Finally, when clicking on each book, a list of web page results appears which are relevant to the book's title.

Timeline Page. According to some embodiments, a search engine results page lists all results in order by way of a timeline.

According to some embodiments, each results page offers two types of search results, specifically, a high level (big data) analysis of what all the results look like at a macro scale, and then what each individual web results looks like.

According to some embodiments, a grid computing method allows each webpage to be read, understood, and displayed back to the user as results pages in a timely manner (“Mining Engine”).

### BRIEF DESCRIPTION OF DRAWINGS

FIG. 1 is a diagram illustrating three components to the Human Threading Search Engine, according to aspects of some embodiments.

FIG. 2 is a diagram illustrating the Human Threading Search Engine Topology, according to aspects of some embodiments.

FIG. 3 is a diagram illustrating the Enterprise Architecture-System Configuration, according to aspects of some embodiments.

FIG. 4 illustrates an example of the Human Threading Search Engine Homepage, according to aspects of some embodiments.

FIG. 5 is a diagram illustrating an example of a topology of software classes according to aspects of some embodiments.

FIG. 6 is a diagram illustrating a relationship between primary web server, the snapshot load balance server, and snapshot server cluster, according to aspects of some embodiments.

FIG. 7A illustrates an example of the portions of a web page extracted in aspects of some embodiments. FIG. 7B illustrates an example of the source code of the portions extracted according to aspects of some embodiments.

FIG. 8 is a diagram illustrating an overview of the Sentiment Class (positive method) and Sentiment Categories Class (all methods) and their respective interaction, according to aspects of some embodiments.

FIG. 9 is a diagram illustrating an overview of the Sentiment Class (negative method) and Sentiment Categories Class (all methods) and their respective interaction, according to aspects of some embodiments.

FIG. 10 is a diagram illustrating an overview of two process modules, according to some embodiments.

FIG. 11 is a diagram illustrating examples of modules included in a webpage generation engine, according to aspects of embodiments.

FIG. 12 is a diagram illustrating a connections result page according to some embodiments.

FIG. 13 is a diagram illustrating views from a dynamic interface showing relevant geographic areas which have been discussed in webpage results, according to some embodiments.

FIG. 14 is an example of a results page with visualized results, according to some embodiments.

FIG. 15A is an example of a view of Sentiment result page, according to some embodiments. FIG. 15B is an example of a view of a lower-level Sentiment results page, according to some embodiments.

FIG. 16A is an example of a bookshelf visualization of search results, according to some embodiments. FIG. 16B is an example of an expanded result page, according to some embodiments.

FIG. 17 is a timeline visualization of search results, according to some embodiments.

FIG. 18 is a diagram of a computer system on which portions of some embodiments may be implemented.

### DETAILED DESCRIPTION OF PREFERRED EMBODIMENTS

Research in cognitive science shows an overwhelming difference in data which is presented visually as opposed to text form Specifically, this research finds that information presented visually has a much stronger impact on humans than text alone. Furthermore, it has been widely publicized that humans remember 10% of what they hear, 20% of what they read, and 80% of what they see visually. There is a strong set of scholarship in this area which supports the notion that humans absorb information in a more efficient manner when that information is visually based (opposed to textual).

Still, this collection of research does not impute that any and all software visualizations are efficient or clear to humans. To the contrary, humans who interact with search engines are often found spending significant time visually trying to comprehend the interface, thus implicating an ineffective mode of displaying visual information.

Some embodiments of the invention provide a search engine yielding neurologically efficient visualizations based on a set of neurophysiologic measurements. These embodiments were developed by combining observations in neuroscience with design science theory and multiple engineering disciplines, and observing human physiological reaction to traditional search engines.

According to aspects of some embodiments, the Human Threading Search Engine (beta name: Ammersion) is an artificially intelligent “web 3.0” search engine. It has been designed by the Human Threading® research process whereby neuroscience and computer science collectively meet to deliver efficient search. In some embodiments, large amounts of search results are read and shown to a user through neurologically efficient visualizations and artificial intelligence. Ammersion utilizes novel methods and processes to connect and unveil search results graphically (rather than manually reading web page after web page).

The power behind this technology is leveraged on top of current search engine page rank mathematics. That is, a ‘Mining Engine’ reads the content of each page from a list of search results obtained from search engine page rank mathematics, and extracts information from the page that is important to the user's search results. Subsequently, a set of results pages are presented to the user as visualizations, which provide different dimensions of result information.

The following terms are used in the description of some embodiments of the invention, and the explanation accompanying the terms are examples of how such terms may be used, but do not limit the terms to only the explanation provided.

Ammersion: beta name given to the Human Threading Search Engine. Ammersion was named after the Human Threading experiment Artificial Immersion. This experiment studies specific gross neural firings across the neocortex of healthy humans while they interact with today's popular search engine web sites.

Apache HTTP Server: The Apache HTTP Server, commonly referred to as Apache, is a web server software notable for playing a key role in the initial growth of the World Wide Web. In 2009 it became the first web server software to surpass the 100 million website milestone. Apache was the first viable alternative to the Netscape Communications Corporation web server (currently named Oracle iPlanet Web Server), and since has evolved to dominate other web servers in terms of functionality and performance. Typically Apache is run on a Unix-like operating systemhttp://en.wikipedia.org/wiki/Apache_HTTP_Server—cite_note-4, and was developed for use on Linux.

Cache: In computer science, a cache includes a component that transparently stores data so that future requests for that data can be served faster. The data that is stored within a cache might be values that have been computed earlier or duplicates of original values that are stored elsewhere. If requested data is contained in the cache, also referred to as a “cache hit”, this request can be served by simply reading the cache, which is comparatively faster. Otherwise, in the case of a “cache miss”, the data has to be recomputed or fetched from its original storage location, which is comparatively slower. Hence, the greater the number of requests that can be served from the cache, the faster the overall system performance becomes.

Client/Server Model: The client/server model includes a computing model that acts as a distributed application which partitions tasks or workloads between the providers of a resource or service, called servers, and service requesters, called clients. Often clients and servers communicate over a computer network on separate hardware, but both client and server may reside in the same system. A server machine may refer to a host that is running one or more server programs which share their resources with clients. Generally, a client does not share any of its resources, but requests a server's content or service function. Clients therefore initiate communication sessions with servers which await incoming requests.

Cluster Analysis: or clustering may refer to the task of assigning a set of objects into groups (called clusters) so that the objects in the same cluster are more similar (in some sense or another) to each other than to those in other clusters.

Conditional Programming: In computer science, conditional statements, conditional expressions and conditional constructs are features of a programming language which perform different computations or actions depending on whether a programmer-specified boolean condition evaluates to true or false. Apart from the case of branch predication, this may be achieved by selectively altering the control flow based on some condition. In imperative programming languages, the term “conditional statement” is usually used, whereas in functional programming, the terms “conditional expression” or “conditional construct” are preferred, because these terms all have distinct meanings.

Daemon: In multitasking computer operating systems, a daemon may refer to a computer program that runs as a background process, rather than being under the direct control of an interactive user. Traditionally daemon names end with the letter d: for example, syslogd is the daemon that implements the system logging facility and sshd is a daemon that services incoming SSH connections. In a Unix environment, the parent process of a daemon is often, but not always, the init process. A daemon is usually created by a process forking a child process and then immediately exiting, thus causing init to adopt the child process. In addition, a daemon or the operating system typically performs other operations, such as dissociating the process from any controlling terminal (tty). Such procedures are often implemented in various convenience routines such as daemon in Unix. Systems often start daemons at boot time and serve the function of responding to network requests, hardware activity, or other programs by performing some task. Daemons can also configure hardware (like udevd on some GNU/Linux systems), run scheduled tasks (like cron), and perform a variety of other tasks.

DMZ: In computer security, a DMZ (sometimes referred to as a perimeter networking) may refer to a physical or logical sub-network that contains and exposes an organization's external-facing services to a larger untrusted network, usually the Internet. The purpose of a DMZ is to add an additional layer of security to an organization's local area network (LAN). When a DMZ is employed, an external attacker may only has access to equipment in the DMZ, rather than any other part of the network. The name is derived from the term “demilitarized zone”, an area between nation states in which military action is not permitted.

Domain Name System: (DNS) may refer to a hierarchical distributed naming system for computers, services, or any resource connected to the Internet or a private network. In some embodiments, it associates various information with domain names assigned to each of the participating entities. A Domain Name Service resolves queries for these names into IP addresses for the purpose of locating computer services and devices worldwide. Domain Name System provides a worldwide, distributed keyword-based redirection service for the Internet.

For loop: In computer science, a for loop may refer to a programming language statement which allows a portion of code to be repeatedly executed. A for loop is classified as an iteration statement. Unlike many other kinds of loops, such as the while loop, the for loop is often distinguished by an explicit loop counter or loop variable. This allows the body of the for loop (the code that is being repeatedly executed) to know about the sequencing of each iteration. For loops are also typically used when the number of iterations is known before entering the loop. For loops are the shorthand way to make loops when the number of iterations is known, as a for loop can be written as a while loop. The name for loop comes from the English word for, which is used as the keyword in most programming languages to introduce a for loop. The loop body is executed “for” the given values of the loop variable, though this is more explicit in the ALGOL version of the statement, in which a list of possible values and/or increments can be specified.

HTML: HyperText Markup Language (HTML) refers to a markup language for specifying how web pages and other information should be displayed in a web browser. HTML is written in the form of HTML elements consisting of tags enclosed in angle brackets (like <html>), within the web page content. HTML tags most commonly come in pairs like <h1> and </h1>, although some tags, known as empty elements, are unpaired, for example <img>. The first tag in a pair is the start tag, the second tag is the end tag (they are also called opening tags and closing tags). In between these tags web designers can add text, tags, comments and other types of text-based content.

HTML Element: an HTML Element may refer to an individual component of an HTML document. HTML documents are composed of a tree of HTML elements and other nodes, such as text nodes. Each element can have attributes specified. Elements can also have content, including other elements and text. HTML elements represent semantics, or meaning. For example, the title element represents the title of the document.

Network Programming: A socket may refer to a host-local, application-created operational system-controlled interface. In this socket the application process can both send and receive messages to/from another application process. In modern programming languages there is a socket API to handle networking. When a communication is to be set up the server creates a TCP socket by creating an object of server socket.

JavaScript: (sometimes abbreviated JS) refers to a prototype-based scripting language that is dynamic, weakly typed and has first-class functions. It is a multi-paradigm language, supporting object-oriented, imperative, and functional programming styles. JSON (JavaScript Object Notation) is a language-independent notation for representing simple data structures and associative arrays, called objects.

Method: In object-oriented programming, a method is a subroutine (or procedure) associated with a class. Methods typically define the behavior to be exhibited by instances of the associated class at program run time. Methods have the special property that at runtime, they have access to data stored in an instance of the class (or class instance or class object or object) with which they are associated, and are thereby able to control the state of the instance. The association between class and method is called binding. A method associated with a class is said to be bound to the class. Methods and can be bound to a class at compile time (static binding) or to an object at runtime (dynamic binding).

Opinion Mining and Sentiment Analysis: An important part of information-gathering behavior is to find out what other people think. With the growing availability and popularity of opinion-rich resources such as online review sites and personal blogs, new opportunities and challenges arise as people can, and do, actively use information technologies to seek out and understand the opinions of others. The sudden eruption of activity in the area of opinion mining and sentiment analysis, which deals with the computational treatment of opinion, sentiment, and subjectivity in text, has thus occurred at least in part as a direct response to the surge of interest in new systems that deal directly with opinions as a first-class object. Opinion Mining and Sentiment Analysis covers techniques and approaches that relate to opinion-oriented information-seeking systems. The focus is on methods that seek to address the new challenges raised by sentiment-aware applications, as compared to those that are already present in more traditional fact-based analysis. The Opinion Mining and Sentiment Analysis includes an enumeration of the various applications, a look at general challenges and discusses categorization, extraction and summarization. Finally, it moves beyond just the technical issues, devoting significant attention to the broader implications that the development of opinion-oriented information-access services have: questions of privacy, vulnerability to manipulation, and whether or not reviews can have measurable economic impact. To facilitate future work, a discussion of available resources, benchmark datasets, and evaluation campaigns is also provided. Opinion Mining and Sentiment Analysis is the first such comprehensive survey of this vibrant and important research area and will be of interest to anyone with an interest in opinion-oriented information-seeking systems.

Pattern Matching: In computer science, pattern matching may refer to the act of checking a perceived sequence of tokens for the presence of the constituents of some pattern. In contrast to pattern recognition, the match usually has to be exact. The patterns generally have the form of either sequences or tree structures. Uses of pattern matching include outputting the locations, if any, of a pattern within a token sequence, to output some component of the matched pattern, and to substitute the matching pattern with some other token sequence (i.e., search and replace).

String Buffer: In object-oriented programming, a String Buffer is an alternative to a String. It has the ability to be altered through adding or appending, whereas a String is normally fixed or immutable.

Virtualization: In computing, virtualization (or virtualisation) may refer the creation of a virtual (rather than actual) version of something, such as a hardware platform, operating system (OS), storage device, or network resources. Virtualization can be viewed as part of an overall trend in enterprise IT that includes autonomic computing, a scenario in which the IT environment will be able to manage itself based on perceived activity, and utility computing, in which computer processing power is seen as a utility that clients can pay for only as needed. The usual goal of virtualization is to centralize administrative tasks while improving scalability and overall hardware-resource utilization. With virtualization, several operating systems can be run in parallel on a single central processing unit (CPU). This parallelism tends to reduce overhead costs and differs from multitasking, which involves running several programs on the same OS.

While loop: In most computer programming languages, a while loop is a control flow statement that allows a portion of code to be executed repeatedly based on a given boolean condition. The while loop can be thought of as a repeating if statement.

I. Enterprise Architecture

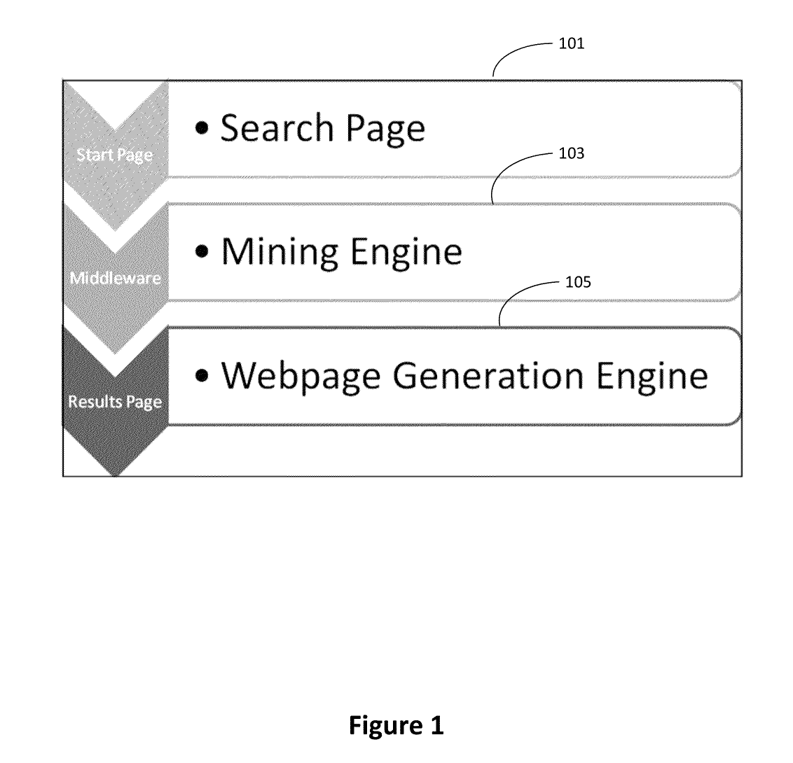

FIG. 1 is a diagram illustrating the components of the Human Threading Search Engine according to some embodiments. It is composed of three high level parts: (1) search page 101, (2) mining engine 103, (3) website generation engine 105.

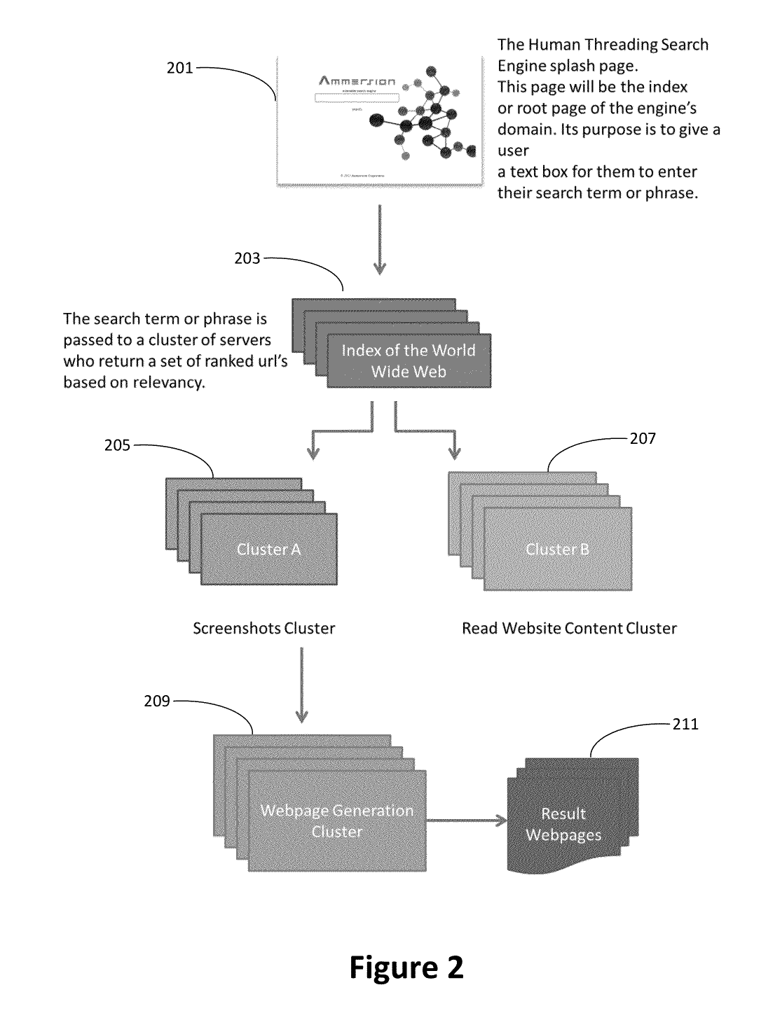

The makeup of these three high level parts has several sub pieces comprised of hardware, software, and networking components. The entire breadth and function of all parts will be referred to as the enterprise architecture. FIG. 2 is a diagram illustrating the workflow of the system as a hierarchal use case from beginning to end of the system's lifecycle, according to some embodiments. It begins with the main splash page 201 of the search engine where a user inputs a search word or phrase.

According to some embodiments, once the user clicks on the respective ‘search’ button on a Search Page such as main splash page 201, the engine takes the query and sends it to search servers. According to some embodiments, search servers will be comprised solely of an application programming interface (API) to an existing search engine. In some embodiments, search servers 203 will be comprised of a cluster of internal web servers which crawl and index the World Wide Web. The search term or phrase is passed to the cluster of search servers 203 who return a set of ranked URLs based on relevancy.

The Mining Engine includes two separate server clusters, Screenshot Cluster (Cluster A) 205 and Read Website Content Cluster (Cluster B) 207. As the results come back one by one, the URLs are each individually sent to Screenshot Cluster 205 and Red Website Content Cluster 207. Servers in Screenshot Cluster 205 get each URL link as an argument and proceed to take a screenshot of the resultant page at the URL. Servers in the Read Website Content Cluster 207 get the same URL link as an argument, but rather than taking a screenshot the servers open the link and inspect the Document Object Model (DOM). According to some embodiments, the servers 207 read the webpages on a one-server-to-one-URL basis and remember particular attributes about the webpage such as people, organizations, words that describe sentiment, locations, and more.

Finally, once the webpages have been identified, imaged, and read, a call to the webpage generation cluster 209 is initiated. Servers of the webpage generation cluster 209 focus on taking information that was learned in the previous step and calling Cluster B 207 to send the stored attributes, such as locations, names, sentiment characteristics, etc., in an effort to build visualizations around the information. Servers 209 use Java to build visualizations of certain web content retrieved from the search results with the pertinent data in Cluster B 207, which is then available to the user as their result pages 211.

Topology of Human Threading Search Engine Network and Server Nodes

With regard to system architecture, in some embodiments, it will take multiple servers running separate parts of the Human Threading Search Engine code base to fulfill a single search request. Inclusion of multiple load balancing technologies will help to accurately and efficiently distribute the workload and generate search results.

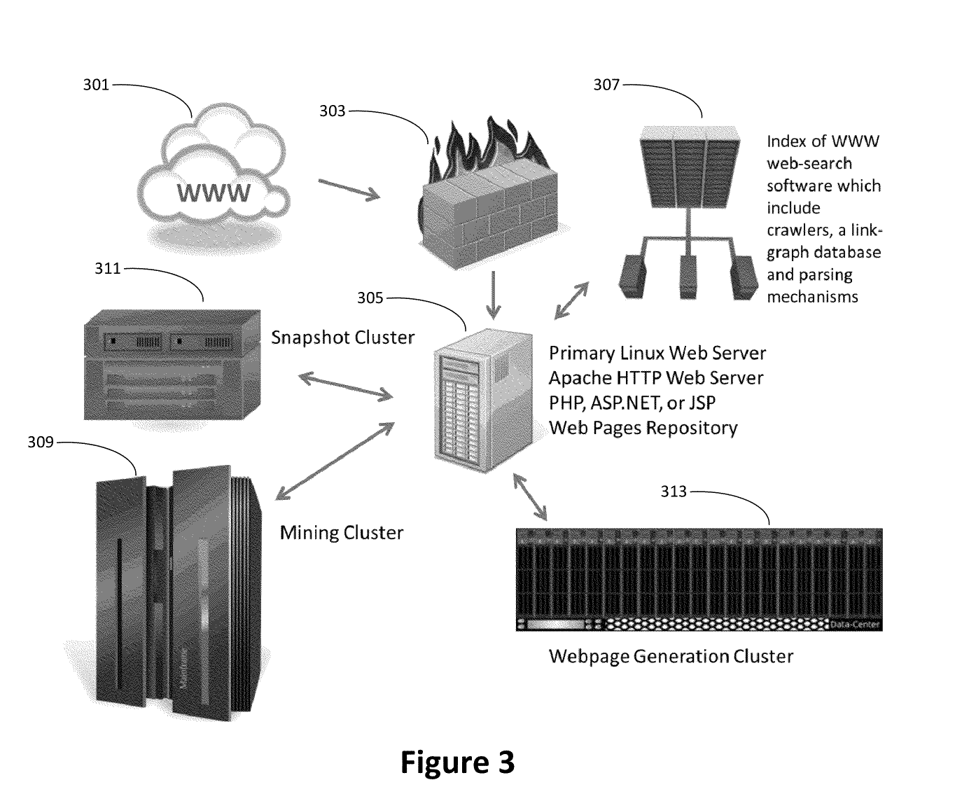

FIG. 3 shows a detailed system overview of the enterprise architecture. It begins with a high level diagram of the World Wide Web 301 connecting to the systems outside firewall 303 via DNS. Though a DMZ is not mentioned it should be expected there will be multiple firewalls with nested DMZs in this configuration. Once inside the core datacenter there will be a primary web server 305, which comprises any one of Apache HTTP server with an enterprise search platform and a web container, PHP server, ASP.NET or other server side processing server. Web server 305 will be the communication link to visiting users as it will directly interact with a user's browser. Web server 305 is also the central articulation point among all other servers in the architecture, wherein all other servers and clusters communicate back and forth only with the primary web server. Other servers are used in this configuration to assist in expediting information for the main web server to host its results pages in a timely manner.

Workflow of Human Threading Search Engine Algorithm

With further reference to FIG. 3 illustrating the enterprise architecture on which some embodiments are implemented, the following describes a process for responding to a user's query by generating graphically represented search results, according to some embodiments. Beginning with the server cluster labeled ‘Index of WWW’ 307, an interactive question and answer session is established whereby Web Server 305 takes the user's query and sends it to ‘Index of WWW’ 307. The ‘Index of WWW’ cluster 307 processes this query and returns a series of relevant links (anywhere from 1 to millions depending on the relevancy of webpages indexed on this cluster). The technologies involved in this cluster use web-search software which include crawlers, a link-graph database and parsing mechanisms to crawl the web and an enterprise search platform to save the indexed information that was found. Software systems that analyze large volumes of unstructured information will mine through the indexed information for additional characteristics relevant to the makeup of each webpage.

Once the primary web server 305 receives answers to the user's question (by way of URL links) it sends each link to a separate, dedicated server inside of two clusters. Each of these dedicated severs consist of custom daemons which acts as a load balancers. These load balancers each take the incoming URL and sends it to a currently unoccupied server for processing. This load balancing server technology sits atop and handles connections from the clusters labeled: ‘Mining Cluster’ 309 and ‘Snapshot Cluster’ 311.

The ‘Snapshot Cluster’ 311 is a relatively straight forward system of servers who are all configured exactly the same. They take a URL as an argument, open the respective webpage, and take a snapshot image of that webpage. The idea behind this system follows the old adage ‘a picture is worth a thousand words’. As discussed in the software section this cluster stores the webpage snapshots and offers it as a search result (substituting a text based result for an image). Each Snapshot server in this cluster 311 sends the produced image back to a directory in the Primary Web Server 305 once completed.

The ‘Mining Cluster’ 309 takes a URL argument and pulls that web address's content in through a software library. To be specific about ‘content,’ the entire source code of a web page is pulled in and analyzed for particular features. Names, organizations, images, video, expressions of times, quantities, monetary values, percentages, multimedia data, locations, dates, miscellaneous attributes, words and phrases which describe sentiment, title, and author information are all captured as features and submitted to an enterprise search platform which resides in the Primary Web Server 305.

Once the ‘Snapshot Cluster’ 311 and ‘Mining Cluster’ 309 have finished their work, a call from the ‘Primary Web Server’ 305 to the ‘Webpage Generation Cluster’ 313 ensues. This cluster does not use a load balancer and each server has different pieces of the Human Threading Search Engine code base. The ‘Webpage Generation Cluster’ 313 gathers information from the enterprise search platform located in the ‘Primary Web Server’ 305 and subsequently builds the results pages. In some embodiments, these pages upon completion are sent to the ‘Primary Web Server’ 305 and any data in its enterprise search platform is completely deleted.

The results pages are intended to be more efficient than conventional search engine result pages as patterns and images are presented to the user as opposed to plain text. These results allow the user to interact with the visualization whereby ultimately the user clicks on a link which takes them to their web page of interest.

Human Threading Search Engine Enterprise Network

It is important to recognize that this configuration is illustrating a single connection between the Human Threading Search Engine and a user. In order to scale to demand, this same configuration grows exponentially. In order to accomplish this task, datacenters of servers will be comprised of the architecture displayed in FIG. 3 many times over. Load balancing appliances will monitor the Primary Web Server 305 for connections and pass new user's requests to another ‘Primary Web Server’ which currently has no connection to it with a user.

Finally, two alterations are made to the system configuration in FIG. 3 during the proposed expansion to scale. First, there will not be a firewall in front of every ‘Primary Web Server’ 305 rather a set of firewalls will be configured for an entire grid of ‘Primary Linux Web Servers’ or perhaps even datacenter. Also, the cluster of servers described in FIG. 3 as ‘Index of WWW’ is available to all ‘Primary Linux Web Servers’. That is to say there is not an individual ‘Index of WWW’ cluster assigned to each ‘Primary Web Server’ 305 in a datacenter. In this scenario the ‘Index of WWW’ cluster is a simple multi-tenancy index of the World Wide Web.

II. Processes

This document has thus far provided a high level overview of a Human Threading Search Engine in regard to its Enterprise Architecture. A system topological overview has been described including server configuration and system lifecycle from search query to results pages.

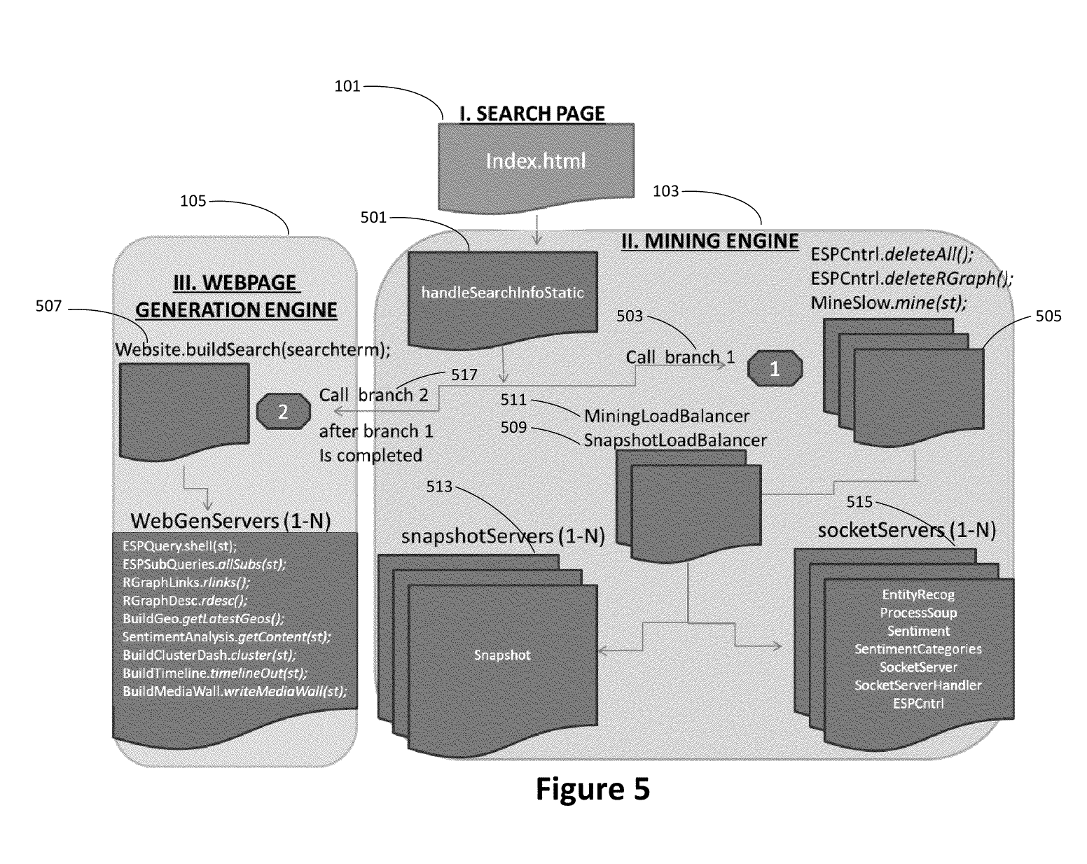

This section will describe the processes which make up the content of the Human Threading Search Engine algorithms, according to some embodiments. FIG. 5 provides an overview of the processes according to some embodiments. It will be organized in descending order from search page to results page according to the three main parts to the Human Threading Search Engine, Search Page 101, Mining Engine 103, and Webpage Generation Engine 105. This linear process will give much finer detail to the enterprise architecture discussed in the previous section.

Search Page

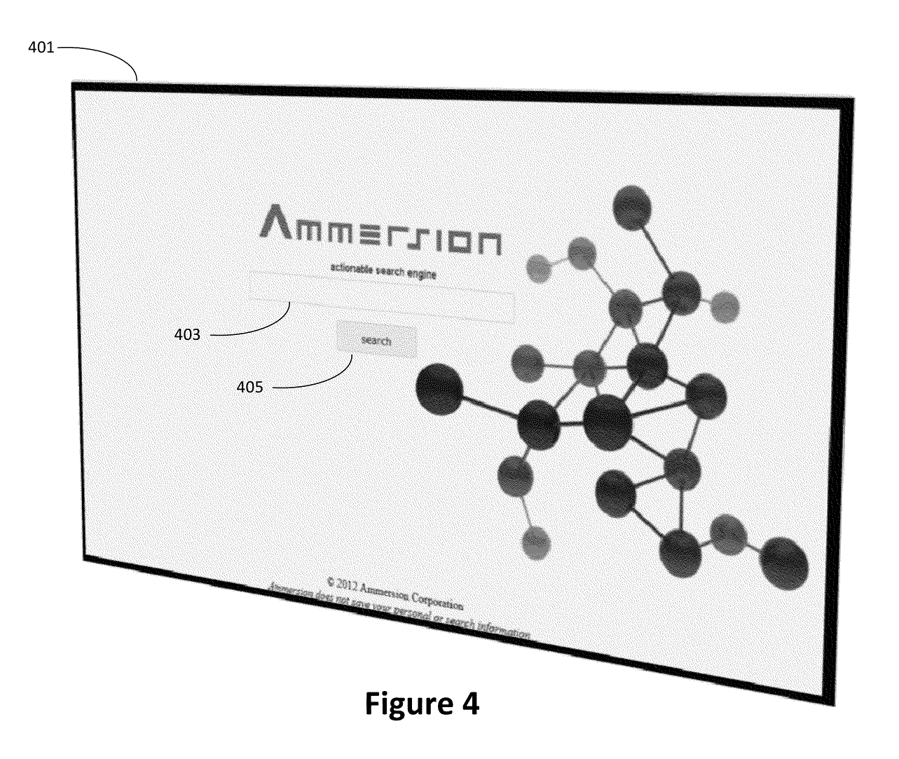

As shown in FIG. 4 the default page or index of the Human Threading Search Engine (Beta name: Ammersion) comprises a simple HTML web page 401, according to some embodiments. Upon loading this webpage, a search term or query phrase is typed into the text box followed by the ‘search’ button being selected, tapped, or clicked by a pointing device or by a tap gesture on a touchscreen input device. This page takes the query typed into the text box and begins the search process with it.

Once the search button has been pressed, a server side processing technology (Java Server Pages, PHP, Java Servlet or ASP. NET for example) is called with the search term or phrase as an argument. This means that the user's search term or phase is passed from its original text box where it was typed to another internal web page for processing. This new server side processing file is not visible to the user; rather it acts as a mechanism between the homepage 101 and the core Human Threading Search Engine algorithms further described in the following sections.

Referring to FIG. 5, once the server side processing file is called on, it sends the search term or phrase to the ‘Mining Engine,’ as described below, and then finally takes the user to the main results page which was created by the Webpage Generation Cluster, as described below.

However, before the page is redirected, two main methods are called to be executed in order. The first main method, referred to as Branch 1, or branch 503, in FIG. 5 calls three other methods from two different classes. The first two methods make sure the enterprise search platform is empty (no entries whatsoever) and the ‘json_desc’ and ‘json_links’ directories are non-existent (more on these directories later in the Mining Engine section). The purpose of this first method is to make sure that the systems cache is clear in an effort to make sure old data is not present which would pollute the search session. Cache here is referring to the folders ‘json_desc’, ‘json_links’, and the ‘enterprise search platform’. If either of these two directories is present or there is data in the enterprise search platform, all are deleted in preparation of the new search process. That is, both folders are deleted and the data inside the enterprise search platform is deleted. This effectively clears our system's cache. In some embodiments, a simple call is made to an existing search engine API. This call takes the query and submits it to a commercial API service, which returns a JSON string with the resultant URL strings. An ‘Index of WWW’ cluster 307 as discussed with reference to FIG. 3 may be used instead of calling a commercial API service. That is to say, an internal search engine may be called rather than a third party search engine.

Following the execution of the first main method, ‘Mining Engine’ as described below, a second method 507 is called which has several nested sub-methods (Branch 2—FIG. 5). This second branch is the ‘Webpage Generation Cluster’ that takes the information stored in cache about each webpage that the ‘Mining Engine’ read and stored into cache and builds visualizations with that information as separate search engine results pages. Once the two main methods are called; the current server side processing technology file redirects the user to their main results page.

Mining Engine

Prior to moving into the nested methods which make up the ‘Mining Engine’, it is important to understand the delineation between these Search Page 101, Mining Engine 103, Webpage Generation Engine 105 as described in detail with reference to FIG. 5. Though all three flow together linearly, there are major functional differences. FIG. 5 displays the major classes in the Human Threading Search Engine codebase which may help to describe how the program works across these three main parts, according to some embodiments.

In Search Page 101, a webpage presents itself to the user and allows them to type in a search term or phrase. the query is taken and is passed it to the ‘Mining Engine’ 103 and the ‘Webpage Generation Engine’ 105. Finally, the user is redirected to the main results page generated by the ‘Webpage Generation Engine’.

‘Mining Engine’ 103 takes the search query and retrieves multiple ranked websites that are relevant to the query. These results are then individually read by the algorithm and particular information (attributes) are then stored in cache for the ‘Webpage Generation Engine’ 105 to form results pages with. For example, if people or organizations are mentioned in the retrieved webpages, those individual people and organizations are copied from the webpage and saved in cache. Simultaneously, while the ‘Mining Engine’ 103 reads the contents of each webpage, a screenshot is taken of that webpage. A screenshot image file is then created and stored in cache along with the webpage's attributes (such as people and organizations, etc.).

Finally, the ‘Webpage Generation Engine’ 105 takes all of the information that was stored in cache by the ‘Mining Engine’ 103 and builds results pages with that data. For example, this section takes all of the names of people stored in cache and builds a visualization that connects them to each other. The purpose is to visually see who is connected to who as a search result page as well as what webpages disclose this information as reference. Another example is locations. This section takes all of the locations found in cache from Section II and plots each location mentioned in a three dimensional globe. The purpose of this is to see where the search query is trending around the world.

Load Balancing in Mining Engine

With reference to FIG. 3, after the call to ‘Index of WWW’ 307, a return of several URL links is sent back to the ‘Primary Web Server’ 305. Referring to FIG. 5, these links are individually sent one by one to two load balance classes SnapshotLoadBalancer 509 and MiningLoadBalancer 511 in front of their respective server clusters snapshotServer cluster 513 and socketServer cluster 515.

According to some embodiments, the class SnapshotLoadBalancer 509 consists of an active socket listening to port 4443 which is running as a daemon on its respective operating system. This class utilizes a method which constantly polls the snapshotServer [1-n] servers 513 under it to see which are working on creating a snapshot and which are free to employ. Furthermore, a host-based analysis method is continually polling the physical hosts associated with the snapshotServer servers 513. What this means is if there are three physical server hosts with hypervisors running 100 guests each, this class's described analysis method measures the amount of random access memory (RAM), CPU utilization, and bandwidth for each host (see: Virtualization above). The purpose for this method is to truly load balance not just the server software, but the environment as a whole. As a result, once the SnapshotLoadBalancer class 509 finds the least utilized and/or geographically closest hardware with a free snapshotServer from the snapshotServers 513, it sends the URL to it. The load balance server running SnapshotLoadBalancer 509 as a daemon connects to the snapshotServers[1-n] 513 through a socket connection listening on port 4444. The load balancer in this scenario acts as a client and server. The server listens for the ‘Primary Web Server’ 305 on port 4443 as a server and forwards the respective URL (and Rank Number) to the available snapshotServer of the snapshotServers[1-n] 513 as a client on port 4444 whereby snapshotServers 513 listen.

Once the available snapshotServer of the snapshotServers[1-n] 513 receives the URL and the URL's respective Rank Number, it calls a method which loads the webpage on its sever and takes a snapshot image of it. Specifically, the process of this snapshot begins with a software library which is capable of opening the html source of the URL. In some embodiments, a Web Scraper, Web Harvester, and/or Web Data Extraction tool is used to pull a webpages' syntax into a String variable. That string variable is then saved as a local html file and then called to open in a browser. As soon as the page loads a snapshot is taken and immediately processed as an image file. This image file is saved as the search rank number back on the ‘Primary Linux Web Server’ for serving back to the user as a search result.

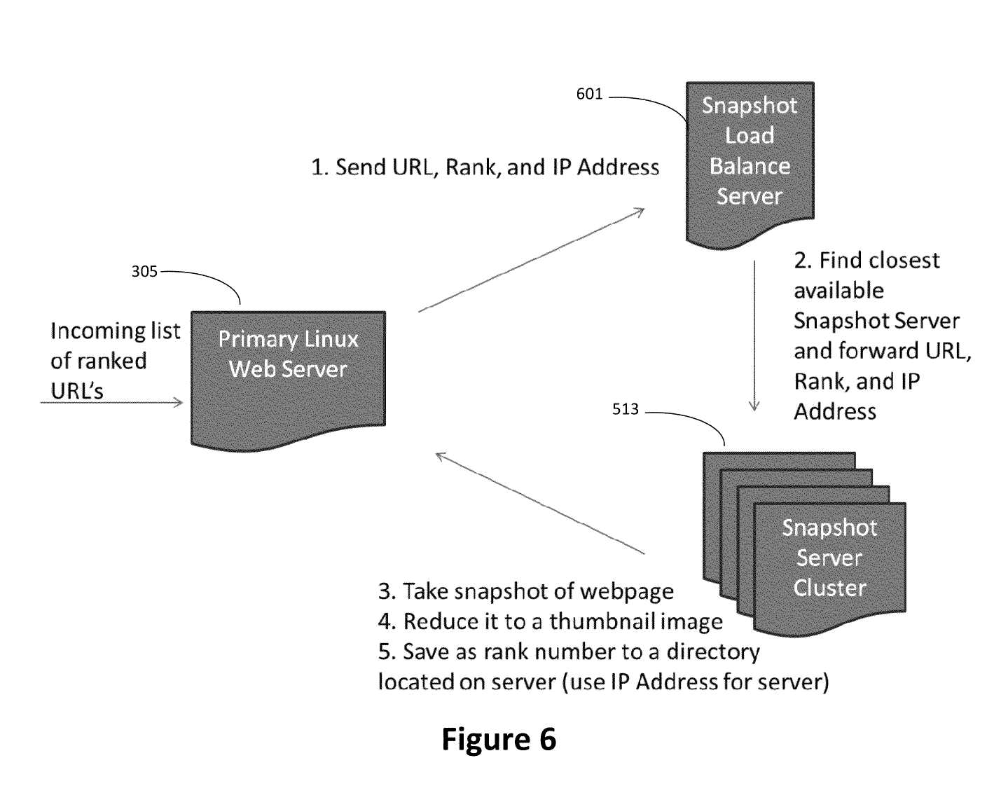

FIG. 6 is a diagram illustrating the interaction between ‘Primary Web Server’ 305, Snapshot Server Cluster 513, and a Snapshot Load Balance Server 601 running SnapshotLoadBalancer 509 as a daemon, according to some embodiments. With reference to FIG. 6, following the snapshot at ‘Snapshot Server Cluster’ 513, a thumbnail picture is generated in conjunction with the webpage content. The thumbnail is then sent to a directory on the ‘Primary Web Server’ 305, with reference to FIG. 3, where the thumbnail is saved with the name of its respective Rank Number. The Rank Number refers to the order number which was sent back from the ‘Index of WWW’ cluster 307. The order is meant to delineate relevancy whereby the first URL sent back is the most relevant followed by the second link, which is second most relevant and so on. The purpose of statically saving the thumbnail image to cache as its rank number allows the ‘Primary Web Server’ 305 a quick and accurate mechanism to link webpage results to its snapshot image.

FIG. 6 shows a visual representation of the relationship between the ‘Primary Web Server’ 305 and the ‘Snapshot Load Balancer’ server 601 and the array (A) of ‘Snapshot Servers’ 513 where

$$A = {\sum }_{t = 0}^{n + 1} A [ 1 … n ] .$$

Similar to the class SnapshotLoadBalancer 509, the MiningLoadBalancer 511 consists of an active socket listening to port 4443 which is running as a daemon on its respective operating system. This class utilizes a method which constantly polls the socketServer [1-n] servers 515 under it to see which are working on creating a snapshot and which are free. Furthermore, a host-based analysis method is continually polling the physical hosts associated with the socketServer servers 515. Exactly as the SnapshotServer scenario above, what this means is if there are three physical server hosts with hypervisors running 100 guests each, this class' described analysis method measures the amount of random access memory (RAM), CPU utilization, and bandwidth for each host (see Virtualization above). Three in this description is just an arbitrary number. The exact number will scale depending on user search volume. The purpose for this method is to truly load balance, not just the server software, but the environment as a whole. As a result, once the MiningLoadBalancer class 511 finds the least utilized and/or geographically closest hardware with a free socketServer, it sends the URL to that server. The load balance server running MiningLoadBalancer 511 as a daemon connects to the socketServer[1-n] 515 through a socket connection listening on port 4444. The load balancer in this scenario acts as a client and server. The server listens for the ‘Primary Web Server’ 305 on port 4443 as a server and forwards the respective URL (and Rank Number) to the available socketServer as a client on port 4444 whereby the socketServer's listen as servers.

Attribute Mining in Mining Engine

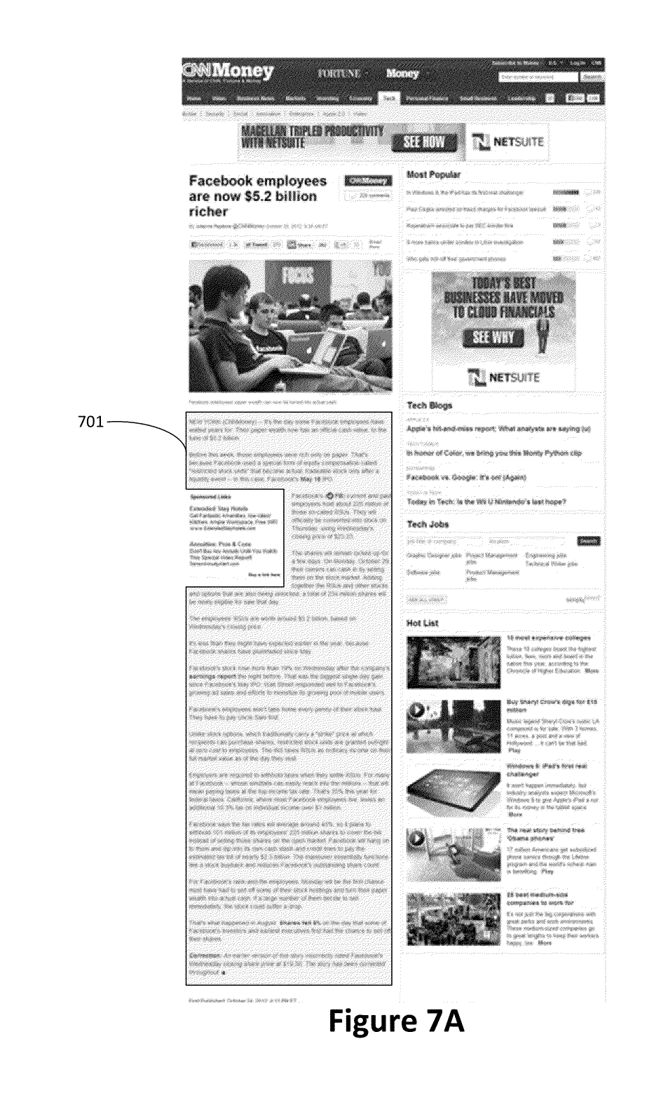

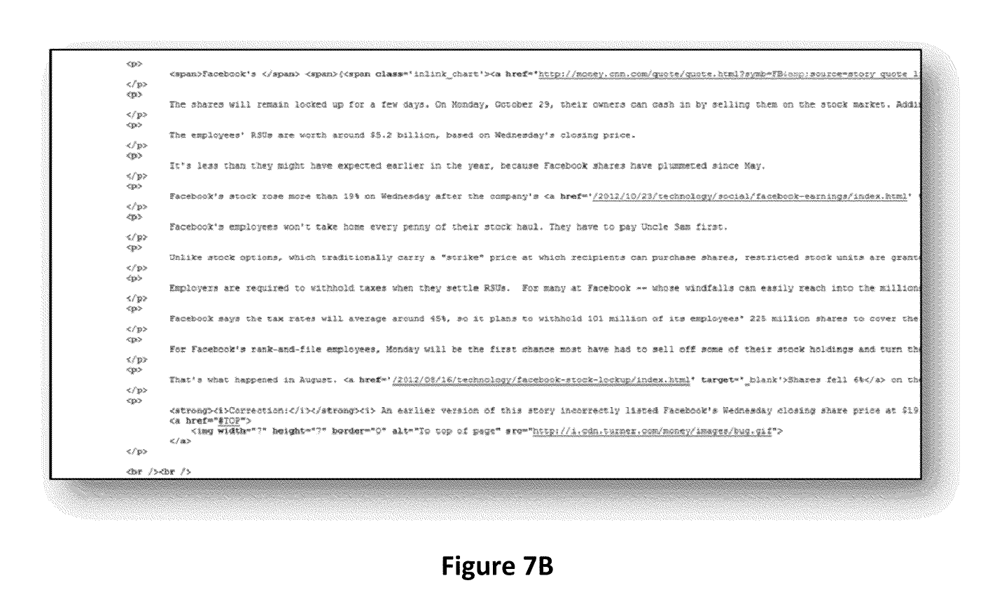

Gathering Web Page Attributes. With reference to FIG. 5, in Mining Engine 103, attributes of the web page, including Title, Author, and Story (main content of webpage), are gathered by the following process, according to some embodiments. Once the socketServer receives the URL, it calls on a class named ProcessSoup to take the URL and load the entire webpage in HTML format. When the ProcessSoup class opens the webpage it immediately searches for the ‘TITLE’ tag (reference Above: HTML and HTML Element) and saves it to a string variable (title variable). Next, the base URL of the webpage is saved to a string variable (author variable). Finally, the content of the webpage is saved where the main webpage's content is saved as a string variable (story variable). The story variable generally provides most if not all of the usable content necessary for the next steps. FIG. 7A shows a real life example of what text 701 the ‘story’ variable will store in class ProcessSoup, according to some embodiments. FIG. 7B shows a view of the text 701 as stored with the HTML encoding intact to form the single string variable ‘story.’

Gathering Sentiment Attributes. In some embodiments, following the identification and storage of the story variable, two methods are called using the string variable ‘story’ as its argument: Sentiment.positive(story); and Sentiment.negative(story). These two methods are both located in the Sentiment class where they take the ‘story’ (sometimes converting its name to ‘content’) and run a series of word banks across the ‘story’ to see if any of the words match.

To gather sentiment attributes, the Mining Engine 103 takes the story variable, which consists of a single word or more likely paragraphs of words derived as the main content or story from a webpage, and individually separates out each word. Each word is compared individually over a series of word banks to see if there is a match. Depending on how many matches between the words in the variable story and the respective word bank, a numeric value is given. For example, if the content contains the word “virtue,” and the word “virtue” is found in the word bank for a positive sentiment, a numeric value is given for the positive sentiment match. In some embodiments, word banks for a particular sentiment may include any words that are conceivably associated with the sentiment.

According to some embodiments, there are eight main sentiment categories (positive sentiment, negative sentiment, economic sentiment, legal sentiment, political sentiment, religious sentiment, military sentiment, and academic sentiment). The positive sentiment category has three word banks that combine to deliver a score based on how many words matched all three banks. Negative sentiment also has three word banks which combine to deliver a score in the same way as positive sentiment. These scores are metrics that are later used in algorithms to compute and deliver a final sentiment value (both positive and negative).

According to some embodiments, economic, legal, political, religious, military, and academic sentiment categories each consist of one word bank each. In the same way positive and negative sentiment categories match words from the story variable to their respective word banks, each of these categories does the same. That is, the story variable is passed through each of these six categories' word banks. The purpose of this is to show not only an overall positive, negative, or neutral score; but also dimensions of sentiment. For example, in a particular search at a particular time, the artist Madonna may have a very positive score, and may have a very heavy emphasis on the dimension of political sentiment. These scores may reflect, for example, her activity in the campaign for President of the United States, and her vocal expressions about it to the press and in her concerts.

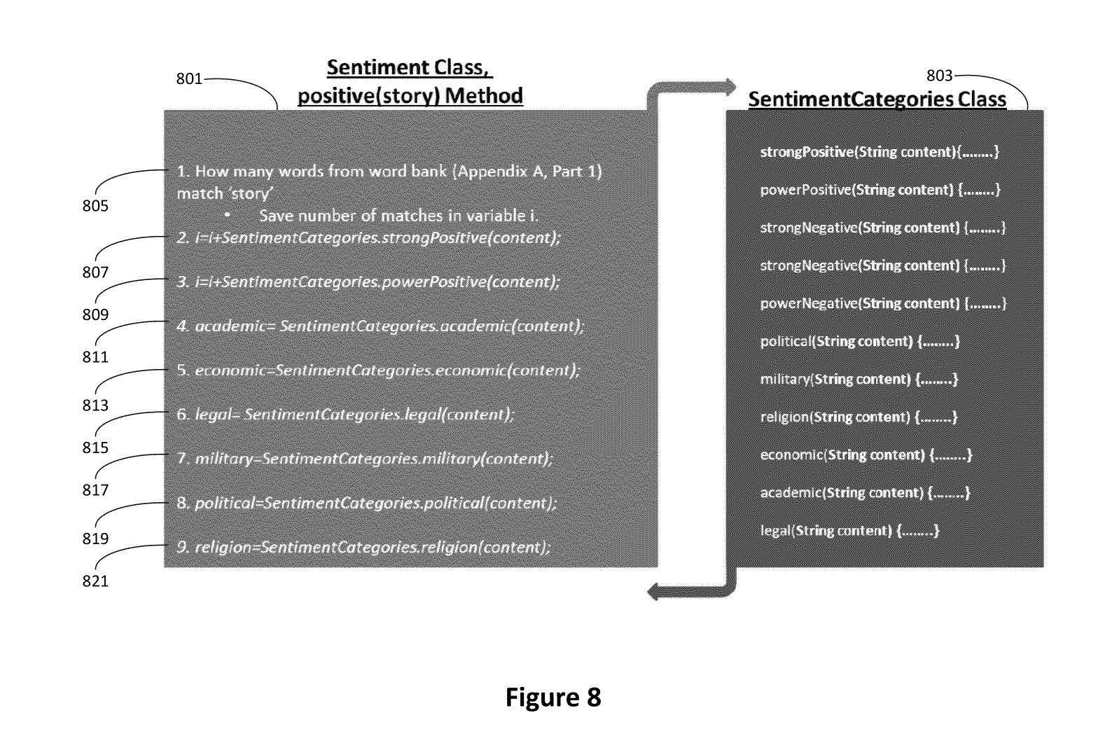

FIG. 8 is a diagram that a visual representation of the operations being executed inside Sentiment.positive(story) 801, and features of the SentimentCategories class 803, according to some embodiments. To illustrate matching of a sentiment with a gathered attribute according to some embodiments, when the method Sentiment.positive(story) is called to determine a positive sentiment score, the ‘story’ string variable is first passed through an arraylist of strings (Positive Sentiment Words) where each string is used in a pattern.compile method (see: Pattern Matching above) and the story string is the matcher.

At stage 805, while each match is found between the story string and the arraylist strings, an integer variable named ‘i’ is incremented by the number 1. Following the matching of the positive arraylist, the story variable is passed to another method called: SentimentCategories.strongPositive(content) whereby the exact same process is executed however with a different arraylist of strings (strongPositive Sentiment Words). While inside the method strongPositive, a ‘while’ loop (see above: While loop) is instantiated analogous to the positive method in the Sentiment class where for each match that is found between the story string and the arraylist strings (strongPositive Sentiment Words), the number 1 is added incrementally to an integer string named ‘i’. When the strongPositive method completes, it returns, as referenced, the integer variable ‘i’ to reflect the positive sentiment score web page.

At stage 807, having determined positive sentiment score ‘i’, once Sentiment.positive(story) calls the method SentimentCategories.strongPositive(content), it adds the local variable ‘i’ of Sentiment.positive(story) to the returned integer ‘i’ of SentimentCategories.strongPositive(content). For example if Sentiment.positive(story).i=1, and SentimentCategories.strongPositive(content) returned an integer equal to 1, the local variable ‘i’ inside Sentiment.positive(story) would now equal 2.

Following the sequence of events thus far inside Sentiment.positive(story), a call to a new method is instantiated: SentimentCategories.powerPositive(content). This method works in an analogous way as SentimentCategories.strongPositive(content), with the difference between SentimentCategories.powerPositive(content) and SentimentCategories.strongPositive(content) being the string variables inside their respective arraylists. Consequently, SentimentCategories.powerPositive(content) will return an integer value the same way SentimentCategories.strongPositive(content) did.

At stage 809, once this integer value is returned, the Sentiment.positive(story) method which originally called SentimentCategories.powerPositive(content) adds its integer value ‘i’ (which is the summation of integer value i inside Sentiment.positive(story) with the retuned integer value of SentimentCategories.strongPositive(content)) to the returned result of SentimentCategories.powerPositive(content). Therefore, the method Sentiment.positive(story) matches words in its arraylist against the ‘story’ variable (renamed to variable word ‘content’ inside Sentiment class) and assigns the matched values with an integer of how many matches were found. This number is stored in its local variable ‘i’. For example, if five words (represented as strings) were found between the variable ‘story’ and the arraylist of string, then the variable ‘i’ would equal 5. It then calls the method SentimentCategories.strongPositive(content) and adds the returned integer to its local variable ‘i’. Further adding to the previous example where the variable ‘i’ equals 5; if SentimentCategories.strongPositive(content) returns an integer value of 6, the new value of the variable ‘i’ in Sentiment.positive(story) would equal 11. Finally, the Sentiment.positive(story) calls the method SentimentCategories.powerPositive(content) in the same manner as it called SentimentCategories.strongPositive(content). It then adds the integer value that is returned from SentimentCategories.powerPositive(content) to its local variable ‘i’. To finish on our example where the variable ‘i’ equals 11; if SentimentCategories.powerPositive(content) returned the value of 9, the new value of local variable ‘i’ inside of Sentiment.positive(story) would equal 20.

According to some embodiments, more methods are called to determine values of other sentiment categories, such as academic economic, legal, military, political, and religion. After the method Sentiment.positive(story) has finished putting together the final value for its local variable ‘i’ it calls one or more of the following methods and then closes. The ‘content’ argument is a string argument which is filled by the ProcessSoup( ) ‘story’ variable in each method below:

1.SentimentCategories.academic(content),

2.SentimentCategories.economic(content),

3.SentimentCategories.legal(content),

4.SentimentCategories.military(content),

5.SentimentCategories.political(content), and

6.SentimentCategories.religion(content)

At stage 811, to assign a value to the variable ‘academic,’ the SentimentCategories.academic(content) method is called. The story string (now called ‘content’) is first passed through an arraylist of strings (academic Sentiment Words) where each string is used in a pattern.compile method (see above: Pattern Matching) and the ‘content’ string is a matcher. While each match is found between the ‘content’ string and the arraylist strings, an integer variable named ‘r’ is incremented by the number 1. This process is analogous to those described above with reference to Sentiment.positive(story), SentimentCategories.strongPositive(content), and SentimentCategories.powerPositive(content). When SentimentCategories.academic(content) is called it returns an integer value. This integer value is then saved in Sentiment.positive(story) as a local integer variable named ‘academic’. As a result, variable ‘academic’ equals SentimentCategories.academic(content).

Similar to stage 811 for the ‘academic’ variable, at stage 813, the SentimentCategories.economic(content) method, is called where the story string (now called ‘content’) is first passed through an arraylist of strings (economic Sentiment Words) where each string is used in a pattern.compile method (see Above: Pattern Matching) and the ‘content’ string is a matcher. While each match is found between the ‘content’ string and the arraylist strings, an integer variable named ‘q’ is incremented by the number 1. When SentimentCategories.economic(content) is called it returns an integer value. This integer value is then saved in Sentiment.positive(story) as a local integer variable named ‘economic’. As a result, variable ‘economic’ equals SentimentCategories.economic(content).

Similar to previous stages, at stage 815, the SentimentCategories.legal(content) method, is called where the story string (now called ‘content’) is first passed through an arraylist of strings (legal Sentiment Words) where each string is used in a pattern.compile method (see Above: Pattern Matching) and the ‘content’ string is a matcher. While each match is found between the ‘content’ string and the arraylist strings, an integer variable named ‘s’ is incremented by the number 1. When SentimentCategories.legal(content) is called it returns an integer value. This integer value is then saved in Sentiment.positive(story) as a local integer variable named ‘legal’. As a result, variable ‘legal’ equals SentimentCategories.legal(content).

Similar to previous stages, at stage 817, the SentimentCategories.military(content) method, is called where the story string (now called ‘content’) is first passed through an arraylist of strings (military Sentiment Words) where each string is used in a pattern.compile method (see Above: Pattern Matching) and the ‘content’ string is a matcher. While each match is found between the ‘content’ string and the arraylist strings, an integer variable named ‘n’ is incremented by the number 1. When SentimentCategories.military(content) is called it returns an integer value. This integer value is then saved in Sentiment.positive(story) as a local integer variable named ‘military’. As a result, variable ‘military’ equals SentimentCategories.military(content).

Similar to previous stages, at stage 819, the SentimentCategories.political(content) method, is called where the story string (now called ‘content’) is first passed through an arraylist of strings (political Sentiment Words) where each string is used in a pattern.compile method (see Above: Pattern Matching) and the ‘content’ string is a matcher. While each match is found between the ‘content’ string and the arraylist strings, an integer variable named ‘m’ is incremented by the number 1. When SentimentCategories.political(content) is called it returns an integer value. This integer value is then saved in Sentiment.positive(story) as a local integer variable named ‘political’. As a result, variable ‘political’ equals SentimentCategories.political(content).

Similar to previous stages, at stage 821, the SentimentCategories.religion(content) method, is called next where the story string (now called ‘content’) is first passed through an arraylist of strings (religion Sentiment Words) where each string is used in a pattern.compile method (see Above: Pattern Matching) and the ‘content’ string is a matcher. While each match is found between the ‘content’ string and the arraylist strings, an integer variable named ‘p’ is incremented by the number 1. When SentimentCategories.religion(content) is called it returns an integer value. This integer value is then saved in Sentiment.positive(story) as a local integer variable named ‘religion’. As a result, variable ‘religion’ equals SentimentCategories.religion (content).

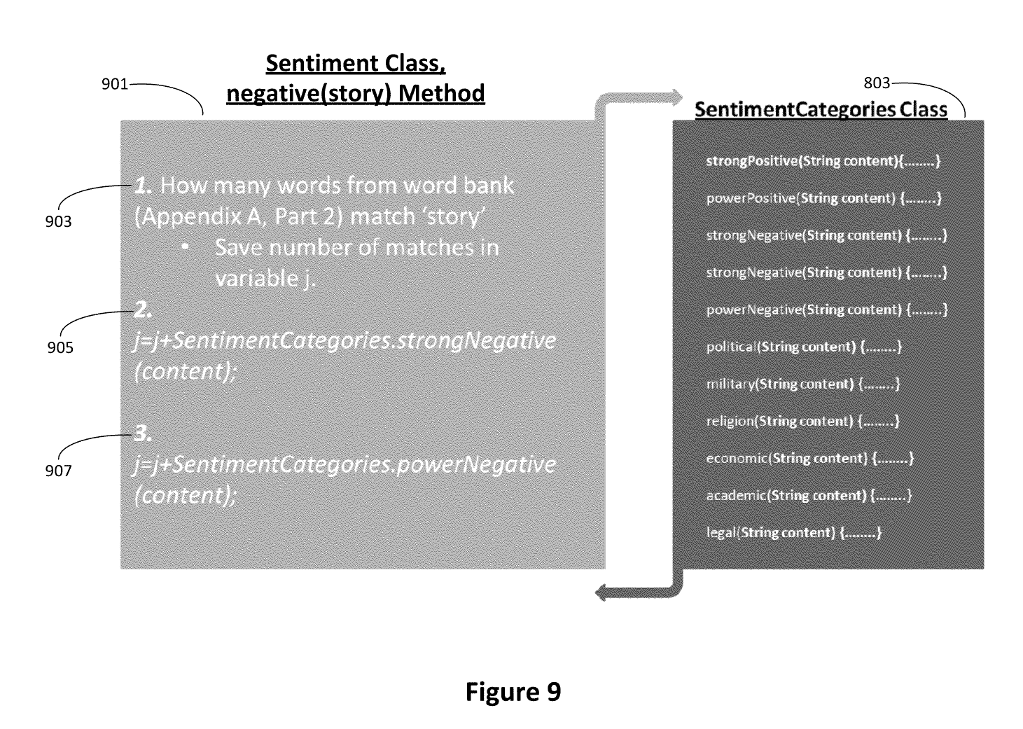

The next step in the Human Threading Search Engine's execution is a call to the method termed ‘negative’ in the Sentiment class (Sentiment.negative(story)). FIG. 9 gives a visual representation of the operations being executed inside Sentiment.negative(story) 901 and details within the SentmentCategories Class 803, according to some embodiments. The negative method inside of the Sentiment class is almost identical to the positive method inside the Sentiment class with some exceptions. First the negative class calls on two outside methods in the Sentiment Categories class called strongNegative(String content) and powerNegative (String content). Second, the negative methods do not call any other methods other than strongNegative(String content) and powerNegative (String content). This is in contrast to the positive method which calls six other methods on top of its respective strongPositive(String content) and powerPositive (String content).

At stage 903, when Sentiment.negative(story) is called, the ‘story’ string variable is first passed through an arraylist of strings (Negative Sentiment Words) where each string is used in a pattern.compile method (see Above: Pattern Matching) and the ‘story’ string variable is a matcher. While each match is found between the ‘story’ string variable and the arraylist strings, an integer variable named ‘j’ is incremented by the number 1. Following the matching of the negative arraylist, the ‘story’ variable is passed to another method called: SentimentCategories.strongNegative(content) whereby an analogous process is executed however with a different arraylist of strings (strongNegative Sentiment Words). While inside the method strongNegative, a ‘while’ loop (reference Above: While loop) is instantiated exactly the same as the negative method in the Sentiment class where each match that is found between the ‘story’ variable and the strongNegative arraylist adds the number 1 incrementally to an integer string named ‘k’. When the strongNegative method completes, it returns the integer variable ‘k’.

At stage 905, once Sentiment.negative(story) calls the method SentimentCategories.strongNegative(content), it adds the local variable ‘j’ of Sentiment.negative(story) to the returned integer ‘k’ of SentimentCategories.strongNegative(content). So for example if Sentiment.negative(story).j=1 and SentimentCategories.strongNegative(content) returned an integer equal to 1. The local variable ‘j’ inside Sentiment.negative(story) would now equal 2.

At stage 907, following the sequence of events thus far inside Sentiment.negative(story), a call to a new method is instantiated: SentimentCategories.powerNegative(content), which is works in a manner analogous to SentimentCategories.strongNegative(content). A difference between SentimentCategories.powerNegative(content) and SentimentCategories.strongNegative (content) is the string variables inside their respective arraylists. SentimentCategories.powerNegative(content) will return an integer value the same way SentimentCategories.strongNegative (content) did. Once this integer value is returned, the Sentiment.negative(story) method which originally called SentimentCategories.powerNegative (content) adds its integer value ‘j’ (which is the summation of integer value j inside Sentiment.negative(story) with the retuned integer value of SentimentCategories.strongNegative(content)) to the returned result of SentimentCategories.powerNegative (content). Therefore, the method Sentiment.negative(story) matches words in its arraylist against the ‘story’ variable (again, renamed to variable word ‘content’ inside Sentiment class) and assigns the matched values with an integer of how many matches were found. This number is stored in its local variable ‘j’. For example if five words (represented as strings) were found between the variable ‘story’ and the arraylist of string, then the variable ‘j’ would equal 5. It then calls the method SentimentCategories.strongNegative(content) and adds the returned integer to its local variable ‘j’. So to add onto the previous example where the variable ‘j’ equals 5; if SentimentCategories.strongNegative(content) returns an integer value of 6, the new value of the variable ‘j’ in Sentiment.negative(story) would equal 11. Finally, the Sentiment.negative(story) calls the method SentimentCategories.powerNegative(content) in the same manner as it called SentimentCategories.strongNegative(content). It then adds the integer value that is returned from SentimentCategories.powerNegative(content) to its local variable ‘j’. To finish on our example where the variable ‘j’ equals 11; if SentimentCategories.powerNegative(content) returned the value of 9, the new value of local variable ‘j’ inside of Sentiment.negative(story) would equal 20.

Once Sentiment.negative(story) has completed its summation of the string arraylists located in Sentiment.negative(story), SentimentCategories.strongNegative(content), and SentimentCategories.powerNegative(content) it exits.

Extracting People, Places, and Things & Submitting all data to cache. According to some embodiments, following the execution of Sentiment.positive(story) and Sentiment.negative(story) described above, one final method ESPCntrl.add( ) is executed. The ESPCntrl class has several methods, all of which directly interact with data store of the enterprise search platform located on the ‘Primary Web Server’ 305. The methods found in the ESPCntrl class include: delete(String id), deleteAll( ) deleteRGraph( ) and add(String title, String siteURl, String author, String content, int pp, int pm, int pr, int pe, int pa, int pl, int positive, int negative), with the following functionality:
delete(String id) method takes a string as an argument and issues a delete command to the enterprise search platform where the string argument is the id of the enterprise search platform's entry;
deleteAll( ) simply deletes the entire contents of the enterprise search platform (cache) leaving no records at all;
deleteRGraph( ) method deletes two directories ‘json_links’ and ‘json_desc’ and all of their associated files stored within them. When called, this method first traverses the ‘Primary Web Server’ 305 file system and deletes the ‘json_links’ directory. It then creates a new directory named ‘json_links’ in the same hard coded path as the previously deleted ‘json_links’ directory. After ‘json_links’ has been created the directory ‘json_desc’ is deleted. A new directory named ‘json_desc’ is then created in the same directory.

The directories ‘json_links’ and ‘json_desc’ hold files that are used by one of the results pages and will be discussed in further detail below. However, it is relevant to the introduction of the ESPCntrl class to describe these directories as they pertain to the method deleteRGraph( ). The location of these directories are somewhere in the ‘Primary Web Server's’ 305 filesystem where the enterprise search platform happens to be located as well.

The directory ‘json_links’ is a hard coded path in this method (as is ‘json_desc’) where a particular set of files are stored in the JSON format. The purpose of this directory is to pre-populate a multitude of relationships and save them as a one-to-one or one-to-many in the JSON format. Each entity that is relevant during a user's search will have their own file created in the JSON format and saved into the ‘json_links’ directory.

For example if a user searched for ‘Madonna’, the name ‘Sean Penn’ would be a trending person in that many websites mention it. Therefore, a JSON file named ‘Sean_Penn_names’ would be saved in the ‘json_links’ directory for later use. The directory ‘json_desc’ holds individual files that are of the exact same name as the files in ‘json_links’. The files in ‘json_desc’ are not in JSON format however, rather HTML format. These files are not complete HTML pages, but are rather tags that will be later used by a results html page. The purpose of the files inside ‘json_desc’ is for holding attributes which help describe their corresponding file in the ‘json_links’ directory. To add to our existing ‘Sean_Penn_names’ example which was created in JSON and saved in ‘json_links’, a corresponding file called ‘Sean_Penn_names’ is also created and saved inside of the ‘json_desc’ folder. This ‘json_desc’ file describes attributes about the JSON file ‘Sean_Penn_names’ such as what website URLs mention Sean Penn and the websites respective titles. These two directories are populated for every single search the Human Threading Search Engine conducts. As a result, these directories are also emptied prior to a user's search so that older files used in another search do not pollute the content of a new users search.
add(String title, String siteURl, String author, String content, int pp, int pm, int pr, int pe, int pa, int pl, int positive, int negative) method. The add( ) method adds new data to the enterprise search platform. However, prior to doing so it first accomplishes a few important tasks.

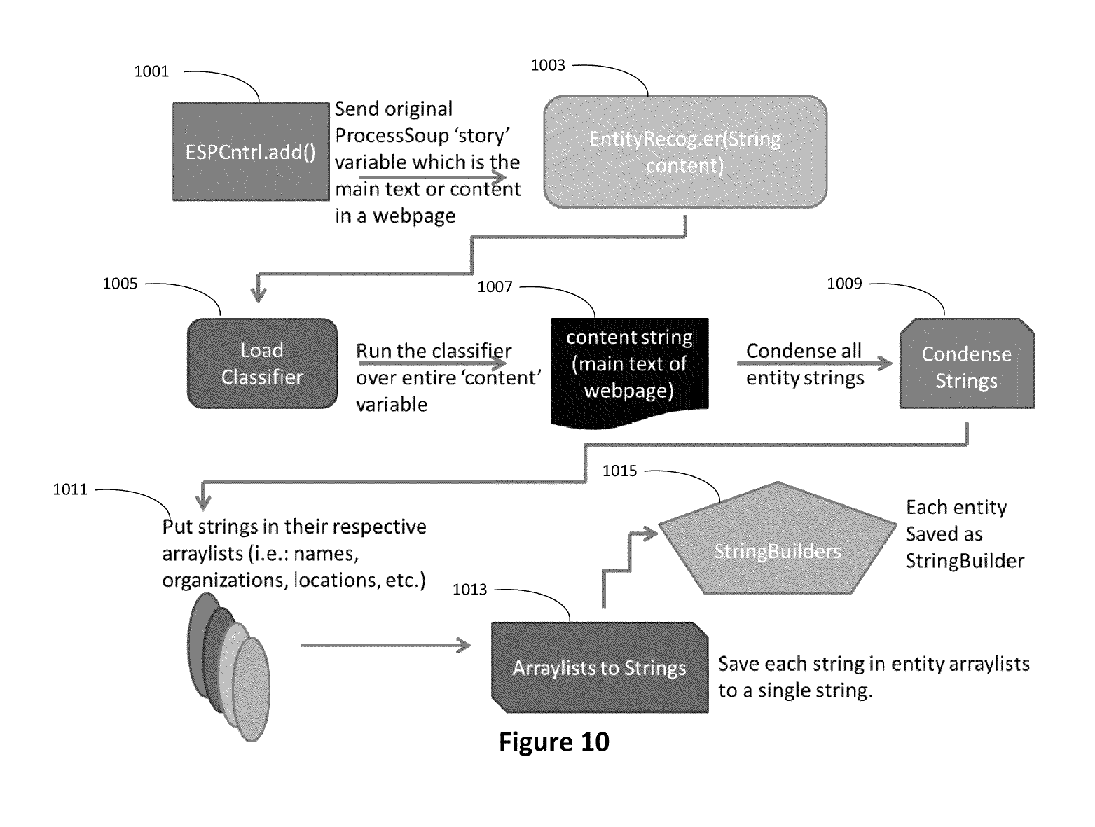

FIG. 10 is a diagram illustrating the operation of the ESPCntrl.add( ) method for classifying content to identify people, places, locations, miscellaneous information, dates and time, etc., in the content according to some embodiments. At stage 1001, the add( ) method executes is a call to the method ‘er(content)’ located inside of the EntityRecog class. At stage 1003, EntityRecog.er(String content) begins by looking for any honorific titles such as: ‘Dr.’, ‘Mr.’, ‘Mrs.’, and ‘Ms.’, and deletes them from the string variable ‘content’ where ‘content’ becomes the variable which receives the data inside of the original variable ‘story’ in ProcessSoup (coming by way of ESPCntrl.add( ).

After the mentioned honorific titles have been removed (if any existed), at stage 1005, the add( ) method proceeds to load a classifying document which is a set of instructions for what defines people's names, organizations, locations, miscellaneous terms (terms which look like names of people or organizations or locations), dates, times, images, video, expressions of times, quantities, monetary values, percentages, miscellaneous data, and multimedia data.

Once this file is loaded into memory, at stage 1007, it goes through the ‘content’ variable and pulls out the entities described above (names, organizations, etc.), saving them to local temporary memory or cache (see above: Cache). The ensuing procedure uses nested ‘if’ statements (see above: Conditional Programming) to take each entity and complete two tasks. At stage 1009, the first task checks to see if the next saved string is one of the same entity type as the current string. If so, it combines the strings as to complete a first and last name of a person, company, location (such as city and state). Once the multi-name strings have been condensed into a single string (if applicable), at stage 1011, the next task takes each entity string and adds it to an arraylist of type String where each arraylist is named after the entity type. Therefore, there is an arraylist named after organizations (IsOrg) which holds all of the organization names found in ‘content’, another arraylist named after locations (IsGeo) which holds all of the locations found in ‘content’, and this goes on for all of the entities described earlier in this paragraph.

Once all of the entity strings found in the ‘content’ variable reside in their respective arraylists, a set of ‘For’ statements are called followed by the creation of a set of StringBuilders which finish off the add( ) method (see: For loop and String Buffer above). At stage 1013, each entity type and corresponding arraylist uses a ‘For’ loop to put each string in the respective arraylist together into one single string (where multiword Strings are attached with an underscore character“_” connecting them). Once the loop ends (based on the size of the arraylist), at stage 1015, a StringBuilder is put in place for each entity which wraps the respective entity's single string in between tags which will allow the enterprise search platform to accept the data.

Succeeding the completion of the process in the above four paragraphs, the contents of a webpage have been mined for people, places, locations, miscellaneous information, dates and time, etc. These mined entities are now stored into cache along with all of the other data which has been mined in this section (title, author, story, sentiment, etc.).

Following the call to EntityRecog.er(String content), ESPCntrl.add( ) formats the current date and time in the following format“yyyy/MM/dd HH:mm:ss” where “yyyy” signifies the year, “MM” is the current month, “dd” is the current day, “HH” stands for hour, “mm” equates to minutes, and finally “ss” stands for seconds. The current time is used here to timestamp the enterprise search platform submission. Once the date and time are formatted and saved to a variable, ESPCntrl.add( ) executes its last operation before closing: submitting a new record to the enterprise search platform's cache located on the ‘Primary Web Server’ 305.

The operation of the Mining Engine concludes with the operation as described hereinafter. Beginning with the socketServer receiving a URL to the class ProcessSoup parsing and calling all external methods, the final operation is a subprocess or ProcessBuilder call to the enterprise search platform located in the ‘Primary Web Server’ 305. This subprocess or ProcessBuilder takes all of the mining results described in this section and submits it as one record to the enterprise search platform. Specifically, a subprocess or ProcessBuilder is instantiated is responsible for taking the tags associated with the subprocess or ProcessBuilder's last argument and submitting to the enterprise search platform located in the ‘Primary Web Server’ 305. The last argument supplied by the subprocess or ProcessBuilder contains tags which look exactly like html tags as well as variables which contain the data that has been mined as described in this section. This argument is passed to the enterprise search platform as a string and submits the following information:

1. Website Title

2. Website Base URL

3. Entire Website URL

4. Date and Time

5. Page Rank

6. Description of Page

7. Meta Data

8. Multimedia Signatures

9. Any of the relevant entities that were found:
a. names of people
b. names of organizations
c. locations
d. dates
e. times
f. images
g. video
h. expressions of times
i. quantities
j. monetary values
k. percentages
l. multimedia data

10. Content Variable

11. Political Sentiment Score (if any)

12. Military Sentiment Score (if any)

13. Religion Sentiment Score (if any)

14. Economic Sentiment Score (if any)

15. Academic Sentiment Score (if any)

16. Legal Sentiment Score (if any)

17. Positive Sentiment Score

18. Negative Sentiment Score

Following a successful submission to the enterprise search platform, Mining Engine 103 with reference to FIG. 5 is now complete and ‘Branch 1’ 503 is no longer active in the Human Threading Search Engine. Webpage Generation Engine 105 is activated at ‘Call Branch 2’ 517.

Webpage Generation Engine

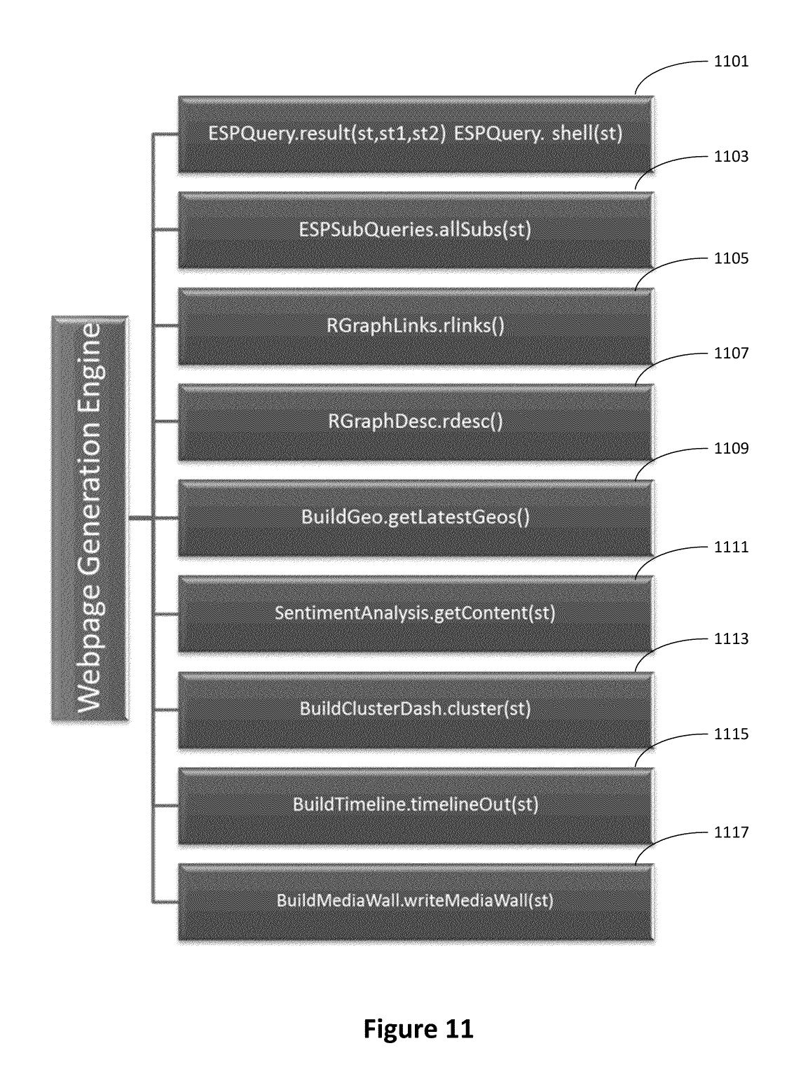

In some embodiments, a Webpage Generation Engine is comprised of several parts. That is, at least several major results pages uniquely utilize the data generated in the Mining Engine 103: results page, connections page, locations page, media wall page, sentiment page, main topics page, and finally the timeline page. Each one of these pages are constructed individually following the completion of the Mining Engine and will be covered one at a time. At a high level, FIG. 11 shows the sequence of operations the Webpage Generation Engine traverses in order to complete the results section of the engine. Each method shown in the illustration may be either sequentially processed or called in parallel as they were designed to be self-sufficient or non-reliant on each other's results to complete. At a high level, this section will show a set of algorithms which take data from cache and individually build a visualization with that data (for example, a location based results page, a sentiment results page, etc.).

As a consequence of the ‘Mining Engine’ 103 two sets of information are now available to the user. The first type of result set is the webpage results showing what the rank of the page is, names of people, names of organizations, locations, sentiment, sentiment types, title, dates, times, images, video, expressions of times, quantities, monetary values, percentages, and multimedia data. However, after discovering all of this information for each webpage, the second type of result set is what the gross data or ‘big’ data shows as an all-in-one result accounting for each webpage examined in the ‘Mining Engine’ 103. This second type of result which displays total aggregate outcomes may provide information that is counter-intuitive or in contrast to many individual webpage results. For example, a search for ‘Madonna’ may to show positive sentiment and a significant amount of location names compared to organizations and people's names. Again, this will all be described below (sections A-G), however upon reading a select set of webpages it became clear that the artist Madonna was in the midst of a tour, thus the reason at a ‘macro scale’ view why there are currently significantly more locations being presented than other attributes (such as names and organizations). To specify on the descriptor ‘macro scale’ this means a visualization which shows so many results it appears as one large pattern or one result representing an entire group (or a single result representing all individual results). Similar to weather on planet earth, humans in each area of the world will feel a different weather pattern, however from the international space station orbiting earth; the astronauts are able to see high level trends at a glance. The Webpage Generation Engine in one form or fashion will address both types of results in a neurologically efficient manner. The first providing mass amounts of information as high level trends and the second as individual webpage information.

Results. With further reference to FIG. 11, at stage 1101, the results page calls on the class ESPQuery.result(st, st1, st2) to return the records which have been received and mined in the previous section. Explicitly, this method takes each records web page rank, title, and description and fills each of these pieces of information into an html template which has preconfigured css and javascript files associated with it. With this relevant information now inserted a user is able to quickly see a snapshot image of each webpage result and its associated title and description referencing each page.

Connections. Further at stage 1101, the connections page begins by calling ESPQuery.shell(st). This is a simple call to the enterprise search platform which generates a visualization of all organizations, names, locations, miscellaneous data found, etc. This visualization provides a high level understanding of total amounts of each category found. The purpose of this first call is the user is able to see the difference in amounts of each entity type found in the mining process. There is no specific information on any webpage with this visualization, only high level differences in amounts found (regarding entities). To use the Madonna example as discussed earlier, this is the page when first loaded showed a large amount of location names dwarfing people and organization names in the connections results page (different from location results page).

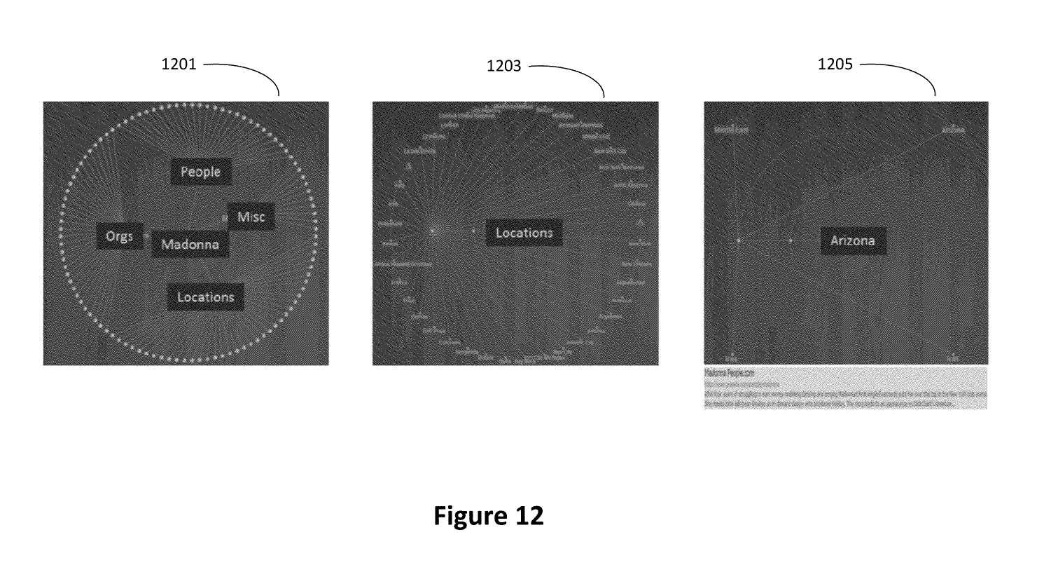

At 1105, 1107, and 1109, respectively, the methods ESPSubQueries.allSubs(st), RGraphLinks.rlink( ) and RGraphDesc.rdesc( ) are called. These calls populate each entity category so that if a user clicks on one of the aforementioned entities the visualization undergoes a metamorphosis into a series of names found regarding the particular entity. FIG. 12 illustrates an example of a connections result page according to some embodiments, whereby each screenshot traversing from left to right represents an action or mouse click taken to ultimately get to their desired webpage. The connections result page allows users to focus on entities as opposed to linear ranked webpage results. For example, using the Madonna scenario from earlier, visualization 1201 shows a large amount of location names mentioned in websites which were mined. If the user clicks on the link referencing the locations (Referenced as: ‘Locations’), the visualization then morphs from showing the user all entities found as a visual pattern(and amounts thereof) to a planetary circle 1203 of names which has the term ‘Locations’ in the middle and on the outer ring words of individual location names (as links). These calls are then available to be clicked to see what websites regarding Madonna mention that specific location. These three described methods allow users to find webpages about their search term or phrase through more than just Search Rank based results. That is, the Connections page allows a user to focus on a specific type of entity (i.e. ‘Locations’) and filter information about their search term (i.e. Madonna) though that entity. Finally, the result of these three methods brings the user to a list of websites which may be significantly different than the results listed in a search rank manner.

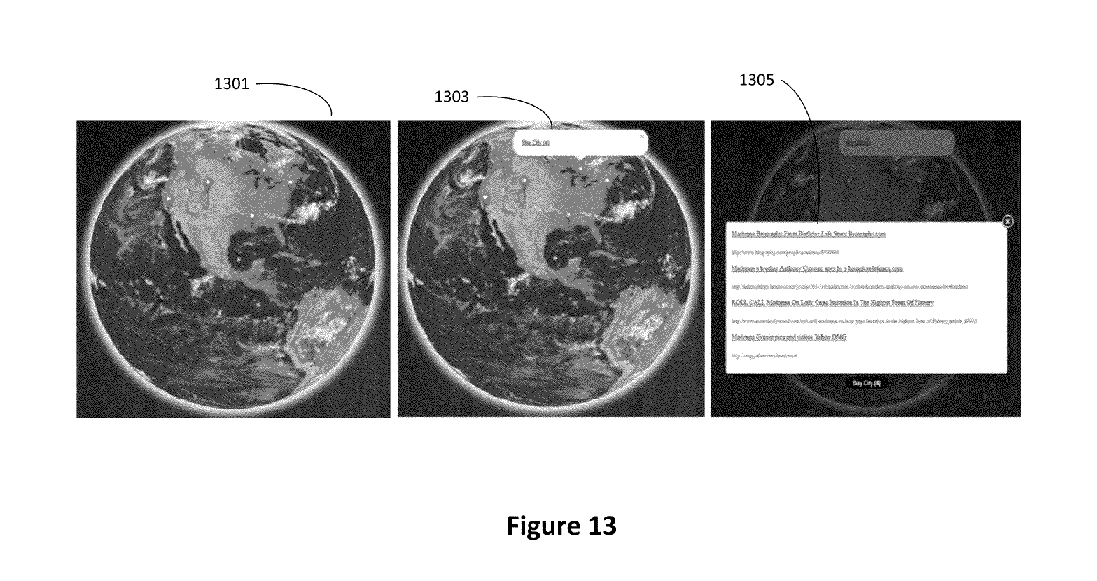

Locations. With further reference to FIG. 11, the BuildGeo.getLatestGeos( ) method is called to populate a results page that is geographically (map) based. FIG. 13 is a diagram illustrating views from a dynamic interface showing relevant geographic areas which have been discussed in webpage results, according to some embodiments. By clicking on a map marker 1301, an indication 1303 of how many websites are associated with an area is revealed. Finally, a click into the indication window opens the associated list of links 1305 which are relevant to the original question and located in the particular region clicked. The dynamic interface allows a progression from loading the ‘Locations’ page to clicking on a particular region, and finally choosing a relevant webpage in that region which potentially answers the question originally asked.

The BuildGeo.getLatestGeos( ) method process involves the following steps:

1. Query the enterprise search platform for all relevant locations found

2. Pass each location through two sets of geographic lists stored in cache which resolve names to latitude/longitude. The first geographic lists stored in cache ‘shortGeo’ contains tens of thousands of the most commonly discussed places in the world. The second geographic list stored in cache: ‘LongGeo’ is a much more extensive list of names of areas in the world which takes a bit longer to resolve in cache.

3. Once each location name is resolved to a latitude/longitude vector, they are inserted into a prebuilt results page with associated css and javascript code. This results page provides a 3Dimensional globe visualization with a heat map feature and Map Markers. In some instances this same map may be displayed in 2 dimensions alternatively (depending on device and browser type).

Similar to the Connections result page, a high level overview 1301 is presented to the user showing them what geographic locations are relevant based on their search term or phrase. The initial vista of this results page is an overview of planet earth showing what places are mentioned and the frequency of those mentioned via Map Markers 1303. This is effectively a ‘big data’ view, showing where the search query results are trending globally. Map Markers are available to be clicked and show the user what websites are mentioned in that geographic area. Once the set of webpages (or a single page) is presented by way of results links 1305, a final click on any webpage link takes the user away from the Human Threading Search Engine domain and into the page of their interest. FIG. 13 thus the progression from loading the ‘Locations’ page to clicking on a particular region, and finally choosing a relevant webpage in that region which potentially answers the question originally asked.

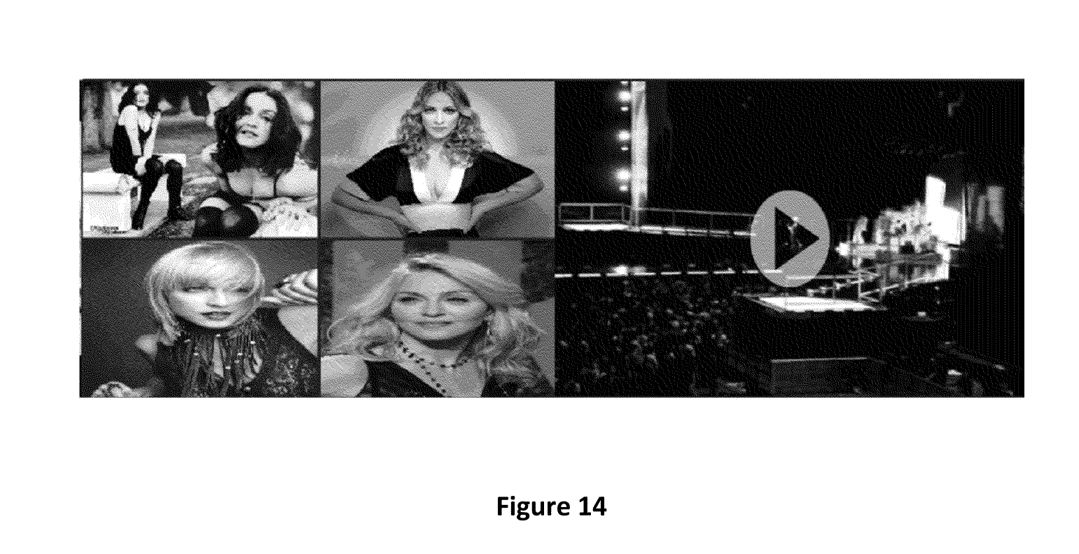

Media Wall. The Media Wall is a results page which takes the original search question and combines it with information found in the ‘Mining Engine’ to deliver deep, relevant multimedia. FIG. 14 is an example of a results page with visualized results, according to some embodiments. The search term ‘Madonna’ reveals images and video from the music artist. On the right hand side of the image a result of ‘Madonna’ and ‘Arizona’ shows her latest concert where ‘Arizona’ at the time of this writing is a trending ‘Location’ topic for her as it was her latest show on tour. Any of the images or video may be played or opened for larger viewing.

Similar to the previous two results pages (and next three), the Media Wall calls a faceted query to the enterprise search platform. As a result the engine returns the most important entities and topics trending at the time regarding the original question.

The Media Wall gathers outside multimedia as well as previously found multimedia (found earlier in ‘Mining Engine’) and assembles it as relevant information for the user. To elaborate, with reference to FIG. 11, once the top names, organizations, etc. (whatever the most popular entities found associated with the search question) are delivered back to the method BuildMediaWall.writemediaWall(st) 1117, it then scours the internet for multimedia which has to do with the original search term or phrase and their trending entities. This identification is either by way of text or pattern recognition. That is to say, a match for the trending term may be through meta data or descriptive text which matches parts of the search question and trending topics, or pattern matching. In this case the search term or phrase is able to confirm an identity of itself, and likewise of its trending topics. Based on these pattern signatures, other relevant information is found and passed back to the Media Wall as related matches. A brief example of this follows the ‘Madonna’ search scenario as discussed earlier. During the ‘Mining Engine’ process a pattern matching process may be instantiated whereby during the course of website mining, a pattern if what ‘Madonna’ is may be identified. In this case the pattern would be a women's face. Furthermore, a trending topic of the search term ‘Madonna’ reveals a person's name ‘Sean Penn’ and enough information has also revealed a pattern referencing ‘Sean Penn’ (in this case a man's face).These signatures are then passed through another search of the internet whereby the likely matching signatures are sent back as relevant by descending date (most recent first). These signatures may be visual-, audio-, scent-, or touch-, or taste-based.

Finally, the Media Wall immerses the user in multimedia results which answer or give brevity to the original question asked. It shows the user an intuitive collage or mash up of their results which may be sorted by described signatures above, as shown in FIG. 14.

Sentiment

The Sentiment results page is instantiated by a SentimentAnalysis.getContent(st) method. This method calls the enterprise search platform for sentiment based entities which were mentioned in the ‘Mining Engine’ section. Multi-document opinion-oriented summarization is conducted (see Above: Opinion Mining and Sentiment Analysis) as a result of calling up the following attributes from the enterprise search platform:
Content Variable
Political Sentiment Score (if any)
Military Sentiment Score (if any)
Religion Sentiment Score (if any)
Economic Sentiment Score (if any)
Academic Sentiment Score (if any)
Legal Sentiment Score (if any)
Positive Sentiment Score
Negative Sentiment Score

Consequently, a set of seven scores are rendered and displayed for the user. Six of these scores are termed ‘characteristics’ and represent: political, military, religion, economic, academic, and legal sentiment. These characteristic scores may be scored from 0-N where N represents infinity. These scores are added together and then each individual score is divided by the sum (and then multiplied by 100) to determine what percentage of each characteristic score represents the sentiment of all webpages returned. Each of these scores are represented as a results page in the form of a meter or gauge button. If a characteristic has the score of zero it will not appear at all. For those characteristics that do have a score higher than zero, each will appear as its own gauge. All characteristic gauges show are the amount of a particular dimension of sentiment that is shown in their results webpages. As a result, any characteristic gauge listed may be clicked on to reveal the list of websites which contain that specific type of sentiment. For example, if we revisit our example of searching for the artist ‘Madonna’ a significant amount of characteristic sentiment focuses on Political and Economic dimensions. By reading the subsequent links associated it seems the artist is outwardly vocal of supporting the U.S. President Barak Obama, hence the rise in respective sentiment characteristics ‘Political’ and ‘Economic’. Finally, the returned result of positive, negative, and/or neutral sentiment is displayed as a larger gauge displaying the overall sentiment found regarding the user's search result.

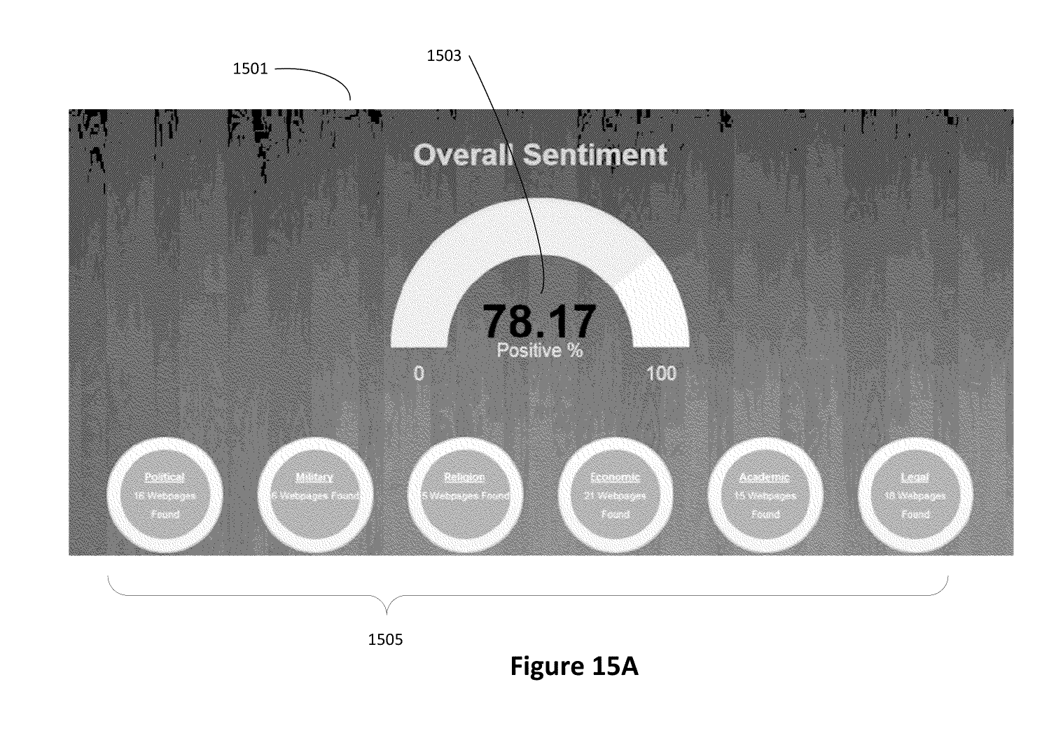

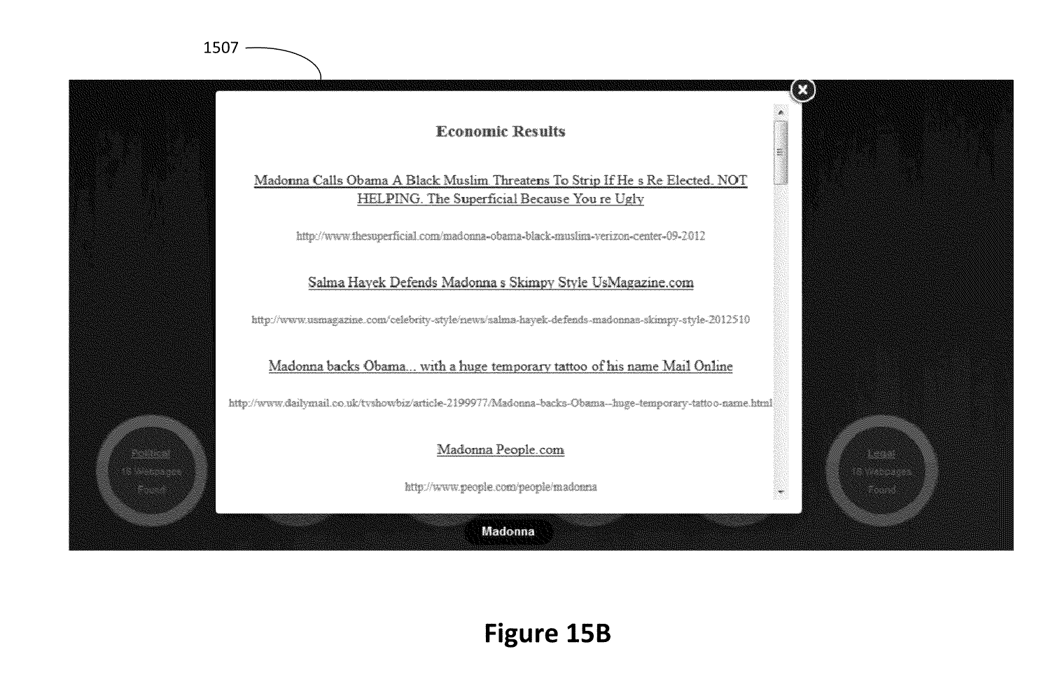

FIG. 15A shows an example of the ‘Sentiment’ result page 1501 showing what the overall sentiment 1503 is regarding search term ‘Madonna’ and what websites were found regarding the six main sentiment characteristics 1505, according to some embodiments. FIG. 15B shows an example of the results window 1507 that comes by way of clicking a particular sentiment characteristic from the set of characteristics 1505. This window reveals the webpages links associated with the respective sentiment characteristic.

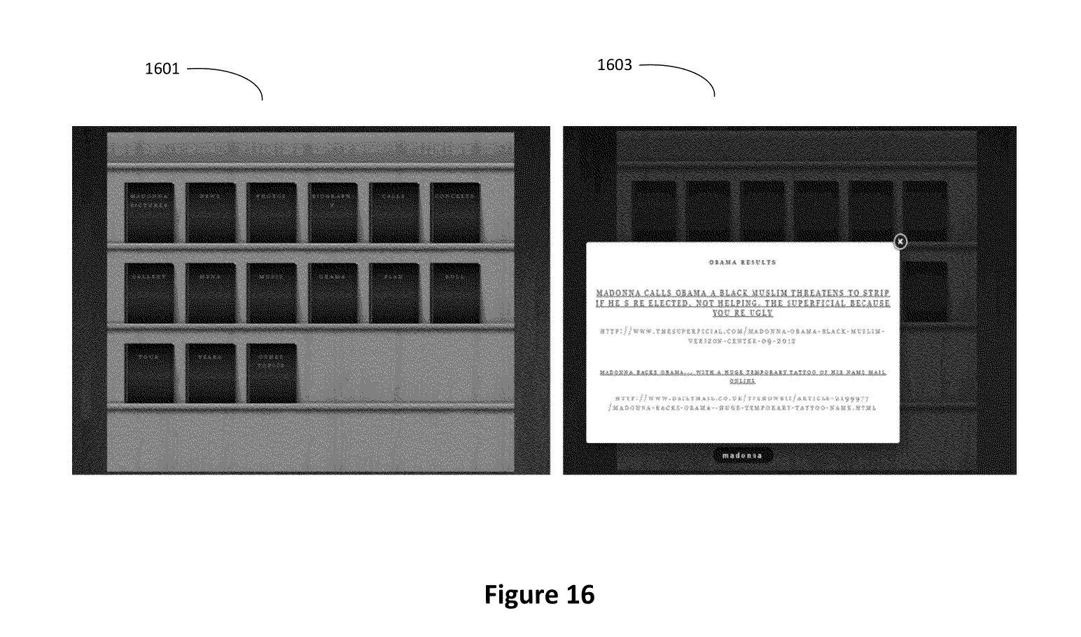

Main Topics. FIG. 16 shows two images which illustrate the ‘Main Topics’ results page. The results page ‘Main Topics’ calls method BuildClusterDash.cluster(st) to the enterprise search platform. Its main purpose is to leverage an internal cache technology (Clustering Engine) to read all of the ‘content’ entries stored as results to a user's question (see Above: Cluster Analysis). Following the clustering call to the enterprise search platform a set of results are returned as Strings whereby each String is a ‘topic’. Each ‘topic’ represents a word or set of words representing one of the main themes among all search result webpages. For example, the Main Topics result page for the search term ‘Madonna’ reveals words such as: ‘Tour’, ‘Obama’, ‘Concerts’, and other terms which represent the most common themes regarding the website search results as a whole (they may also be considered the ‘big data’ view of main topics concerning all webpages read). These returned Strings from the enterprise search platform populate an existing html source code file which is fashioned as a book case. Each book shelf in the case reveals a set of books where their individual titles are one of the returned cluster topics. Finally, by clicking on any book reveals the websites that fall under the topic mentioned as the book title. In the series of execution, BuildClusterDash.cluster(st) is ordered as follows:

1. Call the cache up for the main topic strings

2. Get topic string and associated webpage titles, id's, and URL's

3. Build an array for each topic filling the array with website titles, id's and URL's.

4. Populate the pre-built html file with the newly created arrays where each book's title is named one of the array names (where each array name is a topic string).

5. Fill a popup window with the array contents for each book where the array contents are the webpages associated with the array name (and identical book title).

In FIG. 16, the first image 1601 shows a view of the main topics results page returned from searching the term ‘Madonna’. The right image 1603 shows the result of what happens when clicking on a book. In this example the book ‘Obama’ is clicked. The purpose of this results page is to give the user a different way of absorbing webpage results to their search than just search rank lists. By visualizing a main topic of interest, the answer to one's search question may be more accurately found inside one of the books as opposed to a single list of webpage results.

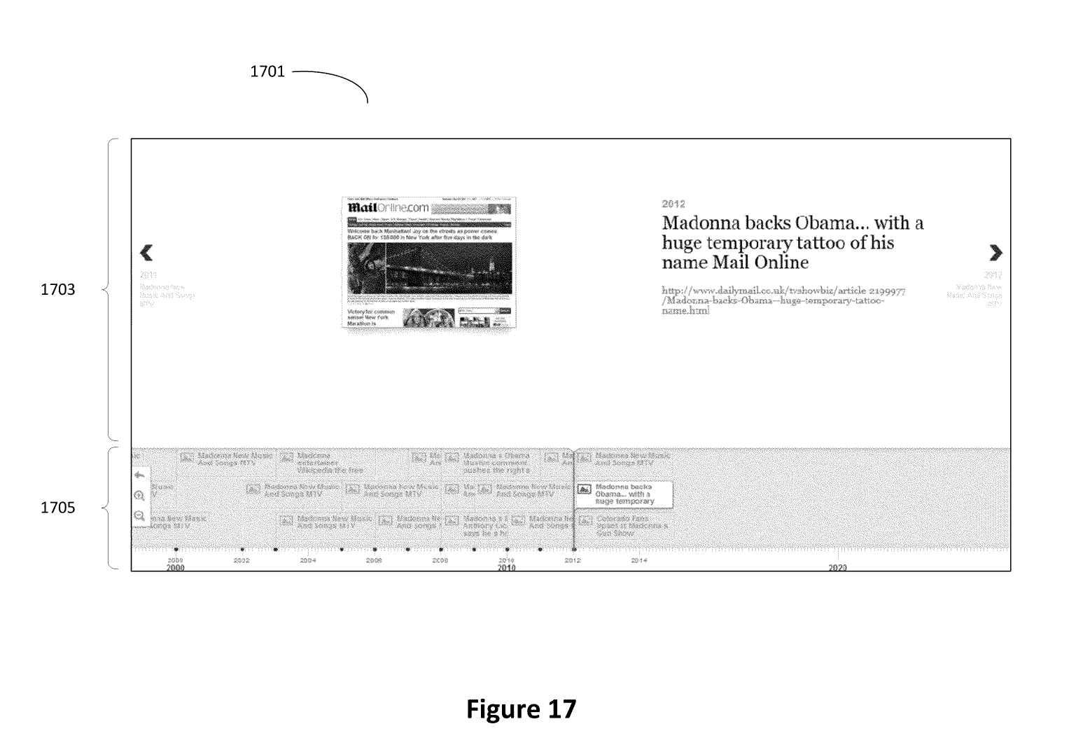

Timeline. The Timeline result page delivers results which have been sorted by date where date is declared in the ‘Mining Engine”s 103 operation. FIG. 17 shows the ‘Timeline’ result page 1701 with the search term ‘Madonna’ where section 1703 is a single webpage snapshot, its associated title, and URL. Section 1705 of the html page shows all of the webpages listed in the ‘Timeline’ result page with the particular page in focus highlighted. According to some embodiments, this page is generated by calling the method BuildTimeline.timelineOut(st) which in turn executes the method BuildTimeline.queryESPTimeline( ) as its first order of operation. BuildTimeline.queryESPTimeline( ) queries the enterprise search platform to return the most relevant website titles, URL's, and dates associated with the search term. With the resultant data, a method BuildTimeline.datematcher(st) is called which passes all of the ‘date’ results through it. BuildTimeline.datematcher(st) processes and resolves ‘date’ data to conform to numerical representation. For example, if there were a date which had the text ‘October’ or shorthand text ‘Oct’, BuildTimeline.datematcher(st) would convert these strings of text to an integer (‘10’ in this case). Once BuildTimeline.datematcher(st) process all dates, they are each appended back to their respective result from cache and saved as a String. So to build on the example above, if the date which was processed by BuildTimeline.datematcher(st) was: ‘Oct. 20, 2012’ it would be processed and saved in cache as: ‘10/20/2012’. Each ‘date’ entry is now saved in a pre-populated html template which lists all of the dates in ascending order from oldest date to newest. A user may now view their webpage results by in a sorted manner by date and time. Again, this offers contrast from a typical search rank list.

Finally, each date listed in the html timeline is accompanied by the URL, title, and the snapshot image of that website. A mouse click on the webpage snapshot, the title, or URL takes the user away from the Human Threading Search Engine and to the webpage they clicked.

III. Hardware Overview

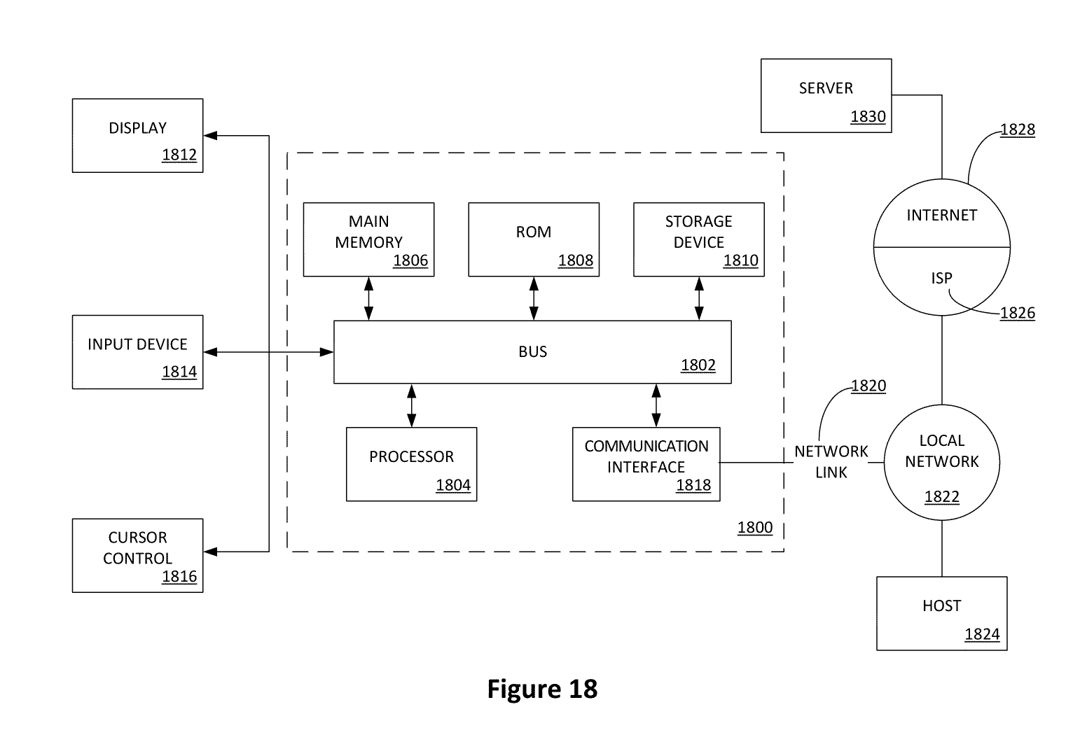

FIG. 18 is a block diagram that illustrates a computer system 1800 upon which some embodiments may be implemented. Computer system 1800 includes a bus 1802 or other communication mechanism for communicating information, and a processor 1804 coupled with bus 1802 for processing information. Computer system 1800 also includes a main memory 1806, such as a random access memory (RAM) or other dynamic storage device, coupled to bus 1802 for storing information and instructions to be executed by processor 1804. Main memory 1806 also may be used for storing temporary variables or other intermediate information during execution of instructions to be executed by processor 1804. Computer system 1800 further includes a read only memory (ROM) 1808 or other static storage device coupled to bus 1802 for storing static information and instructions for processor 1804. A storage device 1810, such as a magnetic disk, optical disk, or a flash memory device, is provided and coupled to bus 1802 for storing information and instructions.

Computer system 1800 may be coupled via bus 1802 to a display 1812, such as a cathode ray tube (CRT) or liquid crystal display (LCD), for displaying information to a computer user. An input device 1814, including alphanumeric and other keys, is coupled to bus 1802 for communicating information and command selections to processor 1804. Another type of user input device is cursor control 1816, such as a mouse, a trackball, or cursor direction keys for communicating direction information and command selections to processor 1804 and for controlling cursor movement on display 1812. This input device typically has two degrees of freedom in two axes, a first axis (e.g., x) and a second axis (e.g., y), that allows the device to specify positions in a plane. In some embodiments, input device 1814 is integrated into display 1812, such as a touchscreen display for communication command selection to processor 1804. Another type of input device includes a video camera, a depth camera, or a 18D camera. Another type of input device includes a voice command input device, such as a microphone operatively coupled to speech interpretation module for communication command selection to processor 1804.

Some embodiments are related to the use of computer system 1800 for implementing the techniques described herein. According to some embodiments, those techniques are performed by computer system 1800 in response to processor 1804 executing one or more sequences of one or more instructions contained in main memory 1806. Such instructions may be read into main memory 1806 from another machine-readable medium, such as storage device 1810. Execution of the sequences of instructions contained in main memory 1806 causes processor 1804 to perform the process steps described herein. In alternative embodiments, hard-wired circuitry may be used in place of or in combination with software instructions to implement the invention. Thus, embodiments are not limited to any specific combination of hardware circuitry and software. In further embodiments, multiple computer systems 1800 are operatively coupled to implement the embodiments in a distributed system.

The terms “machine-readable medium” as used herein refer to any medium that participates in providing data that causes a machine to operate in a specific fashion. In an embodiment implemented using computer system 1800, various machine-readable media are involved, for example, in providing instructions to processor 1804 for execution. Such a medium may take many forms, including but not limited to storage media and transmission media. Storage media includes both non-volatile media and volatile media. Non-volatile media includes, for example, optical disks, magnetic disks, or flash memory devices, such as storage device 1810. Volatile media includes dynamic memory, such as main memory 1806. Transmission media includes coaxial cables, copper wire and fiber optics, including the wires that comprise bus 1802. Transmission media can also take the form of acoustic or light waves, such as those generated during radio-wave and infra-red data communications. All such media must be tangible to enable the instructions carried by the media to be detected by a physical mechanism that reads the instructions into a machine.

Common forms of machine-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, and EPROM, a FLASH-EPROM, flash memory device, any other memory chip or cartridge, a carrier wave as described hereinafter, or any other medium from which a computer can read.

Various forms of machine-readable media may be involved in carrying one or more sequences of one or more instructions to processor 1804 for execution. For example, the instructions may initially be carried on a magnetic disk of a remote computer. The remote computer can load the instructions into its dynamic memory and send the instructions over a data transmission line using a modem. A modem local to computer system 1800 can receive the data on the data transmission line and use an infra-red transmitter to convert the data to an infra-red signal. An infra-red detector can receive the data carried in the infra-red signal and appropriate circuitry can place the data on bus 1802. Bus 1802 carries the data to main memory 1806, from which processor 1804 retrieves and executes the instructions. The instructions received by main memory 1806 may optionally be stored on storage device 1810 either before or after execution by processor 1804.

Computer system 1800 also includes a communication interface 1818 coupled to bus 1802. Communication interface 1818 provides a two-way data communication coupling to a network link 1820 that is connected to a local network 1822. For example, communication interface 1818 may be an integrated services digital network (ISDN) card or other internet connection device, or a modem to provide a data communication connection to a corresponding type of data transmission line. As another example, communication interface 1818 may be a local area network (LAN) card to provide a data communication connection to a compatible LAN. Wireless network links may also be implemented. In any such implementation, communication interface 1818 sends and receives electrical, electromagnetic or optical signals that carry digital data streams representing various types of information.

Network link 1820 typically provides data communication through one or more networks to other data devices. For example, network link 1820 may provide a connection through local network 1822 to a host computer 1824 or to data equipment operated by an Internet Service Provider (ISP) 1826. ISP 1826 in turn provides data communication services through the world wide packet data communication network now commonly referred to as the Internet 1828. Local network 1822 and Internet 1828 both use electrical, electromagnetic or optical signals that carry digital data streams. The signals through the various networks and the signals on network link 1820 and through communication interface 1818, which carry the digital data to and from computer system 1800, are exemplary forms of carrier waves transporting the information.

Computer system 1800 can send messages and receive data, including program code, through the network(s), network link 1820 and communication interface 1818. In the Internet example, a server 1830 might transmit a requested code for an application program through Internet 1828, ISP 1826, local network 1822 and communication interface 1818.

The received code may be executed by processor 1804 as it is received, and/or stored in storage device 1810, or other non-volatile storage for later execution. In this manner, computer system 1800 may obtain application code in the form of a carrier wave.

Other features, aspects and objects of the invention can be obtained from a review of the figures and the claims. It is to be understood that other embodiments of the invention can be developed and fall within the spirit and scope of the invention and claims.

The foregoing description of preferred embodiments of the present invention has been provided for the purposes of illustration and description. It is not intended to be exhaustive or to limit the invention to the precise forms disclosed. Various additions, deletions and modifications are contemplated as being within its scope. The scope of the invention is, therefore, indicated by the appended claims rather than the foregoing description. Further, all changes which may fall within the meaning and range of equivalency of the claims and elements and features thereof are to be embraced within their scope.

What is claimed is:

1. A system for determining sentiments of a search query, comprising one or more computers storing instructions, which when executed by one or more processors causes the computer to perform the steps of:
retrieving content from a plurality of web pages that are associated with results from processing a first search query at a search engine;
analyzing the content for the plurality of web pages to determine a sub-score for a sentiment for each web page of the plurality of web pages;
determining a cumulative score based on the sub-scores for the sentiment for plurality of web pages, wherein the cumulative score determines a sentiment score for the sentiment for the first search query.

2. The system of claim 1, the instructions when executed causes the computer to further perform the steps of:
determining sentiment scores for a set of sentiments, the sentiments including one or more of:
a positive sentiment score;
a negative sentiment score;
a political sentiment score;
a military sentiment score;
a religion sentiment score;
an economic sentiment score;
an academic sentiment score; and
a legal sentiment score, and
generating a visualization of the set of sentiment scores for the first search query.

3. The system of claim 2, the visualization of the set of sentiment scores includes a graphical user interface element relating to a particular sentiment of the set of sentiments, which when selected, provides access to the web pages of the plurality of web pages relating to the sentiment and the first search query.

4. The system of claim 1, wherein the step of analyzing the content for the plurality of web pages to determine the sub-score for the sentiment for each web page of the plurality of web pages comprises the steps of:
maintaining a set of words associated with the sentiment;
comparing words in the content of a web page of the plurality of web pages with the set of words to determine matches between the set of words and words in the content of the web page; and
computing the sub-score based on the comparing.

5. The system of claim 1, the instructions when further executed causes the computer to perform the steps of:
analyzing the content from the plurality of web pages to identify information from the content, and to classify the information into one or more categories, the one or more categories comprising any one or more of people's names, organizations, locations, dates, times, images, video, expression of times, quantities, monetary values, percentages, and multimedia data;
generating one or more visualizations of the results of the first search query, the one or more visualizations comprising graphical elements relating to the one or more categories, a graphical element from a first category selectable to provide access to one or more visualizations of one or more other categories relating to the first category, or to provide access to one or more web pages from the plurality of web pages relating to the results of the first search query based on whether the information from the web page was classified into the first category.

6. The system of claim 5, wherein a location visualization of the one or more visualizations relates to a location category, the visualization comprising an Earth interface corresponding to Earth's geography, the graphical elements for a location corresponding to the location's position on the Earth interface.

7. The system of claim 5, wherein a time visualization of the one or more visualizations relates to a dates and times category, the visualization comprising a timeline and time-based graphical elements corresponding to the time information from the plurality of web pages.

8. The system of claim 5, wherein a persons visualization or an organizations visualization of the one or more visualizations relates to either of the persons or the organizations categories, the visualizations comprising graphical elements relating to one or more persons or organizations.

9. The system of claim 5, wherein each of the graphical user interface elements relating to categories is represented in the visualization as a book on a bookshelf.
